(19) United States
(12) Patent Application Publication
(10) Pub. No.: US 2010/0230619 A1
(43) Pub. Date: Sep. 16, 2010

(54) RADIOACTIVE SUBSTANCE STORAGE CONTAINER, AND METHOD FOR MANUFACTURING RADIOACTIVE SUBSTANCE STORAGE CONTAINER

(75) Inventor: Hiroki Tamaki, Hyogo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 12/741,232

(22) PCT Filed: Dec. 10, 2008
(86) PCT No.: PCT/JP2008/072421

§ 371 Date: May 4, 2010

(30) Foreign Application Priority Data
Dec. 12, 2007 (JP) 2007-321149

(51) Int. Cl. G21F 5/06; G21F 5/10; B31B 7/00

(52) U.S. Cl. 250/506.1; 493/93

(57) ABSTRACT

A radioactive substance storage container 1 includes a trunk body 2, a neutron shielding container 3, and a neutron shielding body 8. The trunk body 2 is a bottomed container including a trunk 2A, a bottom 2B provided at one end of the trunk 2A, and an opening 2H opened to the side opposite from the bottom 2B, and storing therein recycled fuel, and is, for example, manufactured by casting. The neutron shielding container 3 includes a cylindrical inner tube 4 attached to the trunk body 2 by being fitted thereto, a cylindrical outer casing 5 disposed outside the inner tube 4, and heat transfer fins 7 that connect the inner tube 4 and the outer casing 5. The neutron shielding body 8 is disposed in a space surrounded by the inner tube 4, the heat transfer fins 7 and 7 adjacent to each other, and the outer casing 5.

### TECHNICAL FIELD

The present invention relates to a radioactive substance storage container in which radioactive substances such as recycled fuel are stored, and used for transportation and storage.

### BACKGROUND ART

Spent nuclear fuel that is nuclear fuel assemblies used in nuclear power plants and the like, and extracted from a nuclear reactor after being loaded in the nuclear reactor and burned, is called recycled fuel. Spent nuclear fuel assemblies are called recycled fuel assemblies. The recycled fuel contains highly radioactive substances such as a fission product (FP). Accordingly, the recycled fuel is generally cooled in a cooling pit of a nuclear power plant and the like for a certain period of time. The recycled fuel is then stored in a radioactive substance storage container called a cask having a radiation shielding function and used for transportation and storage, is transported to a reprocessing plant or an interim storage facility by a vehicle or a vessel, and stored therein until being reprocessed. Patent document 1 discloses such a radioactive substance storage container.

[Patent document 1] Japanese Patent Application Laid-open No. S59-132397 (pages 1 and 2, FIGS. 2 and 3)

### DISCLOSURE OF INVENTION

### Problem to be Solved by the Invention

A radioactive substance storage container disclosed in Patent document 1 and the like includes a storage container main body portion made of cast iron and a case for containing a radioactive shielding material cast-inserted in the storage container main body portion. The radioactive substance storage container can be relatively easily manufactured by casting, but because dismantling is not taken into account, there is still a room for improvement.

The present invention has been made in view of the above circumstances, and an object of the present invention is to provide a radioactive substance storage container that can be easily dismantled, and a method for manufacturing the radioactive substance storage container.

### Means for Solving Problem

According to an aspect of the present invention, a radioactive substance storage container includes: a trunk body formed of metal that is a bottomed container including a trunk in a cylindrical shape, a bottom provided at one end of the trunk, and an opening opened to a side opposite from the bottom, and that stores a radioactive substance in a space formed by the trunk and the bottom; a neutron shielding container that includes an inner member in a cylindrical shape attached to the trunk body by being fitted thereto, an outer member in a cylindrical shape disposed outside the inner member, and heat transfer members that connect the inner member and the outer member; and a neutron shielding body that is disposed in a space surrounded by the inner member, the outer member, and the heat transfer members adjacent to each other of the neutron shielding container.

In this manner, the inner member of the neutron shielding container is attached to the trunk body by being fitted thereto, and the structures such as transfer fins are not connected to the trunk body by cast bonding, welding, or the like. Accordingly, the radioactive substance storage container can be easily dismantled by removing the inner member from the trunk body.

As an exemplary aspect of the present invention, in the radioactive substance storage container, preferably, the trunk body is a bottomed integral container in which the trunk and the bottom are integrally formed. Accordingly, the radioactive substance storage container can be relatively easily manufactured, because processes of separately manufacturing the trunk and the bottom, and connecting the trunk and the bottom are no longer required.

As an exemplary aspect of the present invention, in the radioactive substance storage container, preferably, the trunk body is made of cast iron. Accordingly, the radioactive substance storage container can be more easily manufactured by casting. Because the inner member of the neutron shielding container is attached to the trunk body by being fitted thereto, the inner member needs not to be welded to the trunk body. Consequently, the neutron shielding container can be attached to the trunk body, even if cast iron that cannot be welded is used for the trunk body. Dismantling is also easy.

As an exemplary aspect of the present invention, in the radioactive substance storage container, preferably, the trunk body has the trunk body and the bottom integrally formed by using a casting mold. Accordingly, the radioactive substance storage container can be more easily manufacture by casting.

As an exemplary aspect of the present invention, in the radioactive substance storage container, preferably, a lubricating material for reducing friction between the trunk body and the inner member is interposed between the trunk body and the inner member. By using the lubricating material, the operation of fitting the inner member of the neutron shielding container to the trunk body can be easily performed, and the operation of removing the inner member from the trunk body can also be easily performed. In this manner, the radioactive substance storage container can be easily dismantled.

As an exemplary aspect of the present invention, in the radioactive substance storage container, preferably, the lubricating material includes a heat conductor. Accordingly, it is possible to provide heat transfer performance from the trunk body to the neutron shielding container without fail.

As an exemplary aspect of the present invention, in the radioactive substance storage container, preferably, the lubricating material is a metal paste or a carbon paste. Accordingly, it is possible to provide heat transfer performance from the trunk body to the neutron shielding container without fail.

As an exemplary aspect of the present invention, in the radioactive substance storage container, preferably, a recess is provided at an outer side of the trunk in a circumferential direction of the trunk. Accordingly, if fluid such as a metal paste is used for the lubricating material, uneven distribution of the lubricating material can be prevented, thereby preventing the trunk body and the inner member of the neutron shielding container from being firmly fixed.

As an exemplary aspect of the present invention, in the radioactive substance storage container, preferably, a release layer for preventing the neutron shielding body from adhering is provided at an inner surface of a space surrounded by the inner member, the outer member, and the heat transfer members of the neutron shielding container. Accordingly, because the neutron shielding body can be easily removed, the radioactive substance storage container can be easily dismantled.

As an exemplary aspect of the present invention, in the radioactive substance storage container, preferably, the neutron shielding container is attached to the trunk body, by using a shrink fit in which the neutron shielding container is fitted to the trunk body after being heated.

As an exemplary aspect of the present invention, in the radioactive substance storage container, preferably, the neutron shielding container is attached to the trunk body, by using a cold shrink fit in which the neutron shielding container is fitted to the trunk body after the trunk body is cooled.

As an exemplary aspect of the present invention, in the radioactive substance storage container, preferably, the neutron shielding container is fixed to the trunk body by an engagement member provided at the trunk body. In this manner, by using the engagement member, the neutron shielding container can be fixed to the trunk body without fail, and by removing the engagement member, the operation of removing the neutron shielding container can also be easily performed.

As an exemplary aspect of the present invention, in the radioactive substance storage container, preferably, the engagement member is provided in plurality in a circumferential direction of the trunk body. Accordingly, because the load of the neutron shielding container can be uniformly received by the engagement members, it is possible to prevent an excessive load from being applied locally.

As an exemplary aspect of the present invention, in the radioactive substance storage container, preferably, the engagement member is a hoisting attachment provided at the trunk body, and used for hoisting at least the radioactive substance storage container. In this manner, the neutron shielding container can be fixed to the trunk body without fail by using the hoisting attachment, and by removing the hoisting attachment, the operation of removing the neutron shielding container can also be easily performed.

As an exemplary aspect of the present invention, in the radioactive substance storage container, preferably, the neutron shielding container is divided in a longitudinal direction of the trunk body. Accordingly, even if the trunk body includes a portion having a complicated shape, the neutron shielding container attached to the portion can be manufactured separately. Consequently, it is possible to prepare the neutron shielding container matched with the portion having a complicated shape.

As an exemplary aspect of the present invention, in the radioactive substance storage container, preferably, the neutron shielding container provided at the opening of the trunk body among the neutron shielding containers being divided, is divided in a circumferential direction of the neutron shielding container. Accordingly, even if a neutron shielding container formed as an integral structure cannot be attached, the neutron shielding container can be attached to the trunk body by being divided into shapes that can be attached thereto.

According to another aspect of the present invention, a method for manufacturing a radioactive substance storage container includes: a step of disposing a neutron shielding body in a space surrounded by an inner member, an outer member, and heat transfer members adjacent to each other of a neutron shielding container including the inner member in a cylindrical shape, the outer member in a cylindrical shape disposed outside the inner member, and the heat transfer members that connect the inner member and the outer member; and a step of fitting the neutron shielding container to a trunk body that is a bottomed container including a trunk in a cylindrical shape, a bottom provided at one end of the trunk, and an opening opened to a side opposite from the bottom.

In this manner, the inner member of the neutron shielding container is attached to the trunk body by being fitted thereto, and the structures such as the heat transfer fins are not connected to the trunk body by cast bonding, welding, or the like. Accordingly, the radioactive substance storage container can be easily dismantled, by removing the inner member from the trunk body.

According to still another aspect of the present invention, a method for manufacturing a radioactive substance storage container includes: a step of fitting a neutron shielding container including an inner member in a cylindrical shape, an outer member in a cylindrical shape disposed outside the inner member, and heat transfer members that connect the inner member and the outer member, to a trunk body that is a bottomed container including a trunk in a cylindrical shape, a bottom provided at one end of the trunk, and an opening opened to a side opposite from the bottom; and a step of disposing a neutron shielding body in a space surrounded by the inner member, the outer member, and the heat transfer members adjacent to each other of the neutron shielding container.

In this manner, the inner member of the neutron shielding container is attached to the trunk body by being fitted thereto, and the structures such as the heat transfer fins are not connected to the trunk body by cast bonding, welding, or the like. Accordingly, the radioactive substance storage container can be easily dismantled, by removing the inner member from the trunk body.

As an exemplary aspect of the present invention, in the method for manufacturing the radioactive substance storage container, preferably, a lubricating material for reducing friction between the trunk body and the inner member is applied at least to one of an inner periphery of the inner member of the neutron shielding container and an outer periphery of the trunk body, before the neutron shielding container is fitted to the trunk body. By using the lubricating material, the operation of fitting the inner member of the neutron shielding container to the trunk body can be easily performed, and the operation of removing the inner member from the trunk body can also be easily performed. As a result, the radioactive substance storage container can be easily dismantled.

To solve the above-mentioned problems and to achieve the object, a method for manufacturing the radioactive substance storage container according to the present invention includes: a step of fitting an inner member in a cylindrical shape to a trunk body that is a bottomed container including a trunk in a cylindrical shape, a bottom provided at one end of the trunk, and an opening opened to a side opposite from the bottom; a step of attaching heat transfer members outside the inner member; a step of attaching an outer member in a cylindrical shape outside the heat transfer members; and a step of disposing a neutron shielding body in a space surrounded by the inner member, the outer member, and the heat transfer members adjacent to each other of the neutron shielding container.

In this manner, the inner member of the neutron shielding container is attached to the trunk body by being fitted thereto, and the structures such as the heat transfer fins are not connected to the trunk body by cast bonding, welding, or the like. Accordingly, the radioactive substance storage container can be easily dismantled, by removing the inner member from the trunk body.

To solve the above-mentioned problems and to achieve the object, a method for manufacturing the radioactive substance storage container according to the present invention includes: a step of fitting an inner member in a cylindrical shape to a trunk body that is a bottomed container including a trunk in a cylindrical shape, a bottom provided at one end of the trunk, and an opening opened to a side opposite from the bottom; a step of attaching heat transfer members to an inner side of an outer member in a cylindrical shape disposed outside the heat transfer members; a step of disposing the heat transfer members and the outer member outside the inner member, and attaching the heat transfer members outside the inner member; and a step of disposing a neutron shielding body in a space surrounded by the inner member, the outer member, and the heat transfer members adjacent to each other of the neutron shielding container.

In this manner, because the inner member of the neutron shielding container is attached to the trunk body by being fitted thereto, and the structures such as the heat transfer fins are not connected to the trunk body by cast bonding, welding, or the like, the radioactive substance storage container can be easily dismantled, by removing the inner member from the trunk body

As an exemplary aspect of the present invention, in the method for manufacturing the radioactive substance storage container, preferably, a lubricating material for reducing friction between the trunk body and the inner member is applied, at least to one of an inner periphery of the inner member and an outer periphery of the trunk body, before the inner member is fitted to the trunk body. By using the lubricating material, the operation of fitting the inner member of the neutron shielding container to the trunk body can be easily performed, and the operation of removing the inner member from the trunk body can also be easily performed. As a result, the radioactive substance storage container can be easily dismantled.

### EFFECT OF THE INVENTION

The present invention can provide a radioactive substance storage container that can be easily dismantled.

### BRIEF DESCRIPTION OF DRAWINGS

FIG. 1 is a schematic of an overall configuration of a radioactive substance storage container according to a present embodiment.

FIG. 2 is a perspective view of an example of a basket of the radioactive substance storage container according to the present embodiment.

FIG. 3 is sectional views of the radioactive substance storage container according to the present embodiment, cut along a plane that passes through an axis of the radioactive substance storage container according to the present embodiment, and a plane perpendicular to the axis.

FIG. 4A is a fragmentary view taken along the line A-A in FIG. 3, depicting a state in which a neutron shielding container according to the present embodiment is not attached.

FIG. 4B is a fragmentary view taken along the line A-A in FIG. 3, depicting a state in which the neutron shielding container according to the present embodiment is attached.

FIG. 4C is a perspective view of a neutron shielding body included in the neutron shielding container according to the present embodiment.

FIG. 5 is a perspective view depicting a state in which the radioactive substance storage container according to the present embodiment is disassembled into a trunk body and a neutron shielding container.

FIG. 6A is a schematic for explaining an example of a structure for fixing a key.

FIG. 6B is a schematic for explaining an example of a key.

FIG. 7 is a schematic for explaining another example of a structure for fixing a key.

FIG. 8A is a schematic for explaining another example of a structure for fixing a key.

FIG. 8B is a schematic for explaining another example of a structure for fixing a key.

FIG. 9A is a schematic for explaining an alternative structure of a key.

FIG. 9B is a schematic for explaining an alternative structure of a key.

FIG. 10A is a schematic for explaining an example of a sealing structure between the neutron shielding container and the trunk body.

FIG. 10B is a schematic for explaining an example of a sealing structure between the neutron shielding container and the trunk body.

FIG. 11 is a schematic of a state in which the neutron shielding container is attached to the trunk body.

FIG. 12A is a schematic for explaining a structure of a bottom of the radioactive substance storage container according to the present embodiment.

FIG. 12B is a schematic for explaining a structure of a bottom of the radioactive substance storage container according to the present embodiment.

FIG. 12C is a schematic for explaining a structure of a bottom of the radioactive substance storage container according to the present embodiment.

FIG. 12D is a schematic for explaining a structure of a bottom of the radioactive substance storage container according to the present embodiment.

FIG. 13 is a sectional view of a radioactive substance storage container according to a first modification of the present embodiment, cut along a plane that passes through the axis of the radioactive substance storage container according to the present embodiment.

FIG. 14A is a fragmentary view taken along the line A-A in FIG. 3, depicting a state in which the neutron shielding container according to the present embodiment is attached.

FIG. 14B is a fragmentary view taken along the line A-A in FIG. 3, depicting a state in which the neutron shielding container according to the present embodiment is not attached.

FIG. 15 is an enlarged view of a split portion of the neutron shielding container.

FIG. 16A is an enlarged view of a structure of the split portion of the neutron shielding container according to the first modification of the present embodiment.

FIG. 16B is an enlarged view of a structure of the split portion of the neutron shielding container according to the first modification of the present embodiment.

FIG. 17 is a sectional view of a radioactive substance storage container according to a second modification of the present embodiment, cut along a plane that passes through the axis of the radioactive substance storage container according to the present embodiment.

FIG. 18 is a sectional view of a radioactive substance storage container according to a third modification of the present embodiment, cut along a plane that passes through the axis of the radioactive substance storage container according to the present embodiment.

FIG. 19 is a sectional view of a radioactive substance storage container according to a fourth modification of the present embodiment, cut along a plane that passes through the axis of the radioactive substance storage container according to the present embodiment.

FIG. 20 is an enlarged view near a flange portion of a radioactive substance storage container according to a fifth modification of the present embodiment.

### EXPLANATIONS OF LETTERS OR NUMERALS

1, 1a, 1b, 1c, 1d, 1e radioactive substance storage container
2P trunnion mount
2F, 2Fc, 2Fd flange portion
2H, 2Hc, 2Hd opening
2D step portion
2B, 2Bd bottom
2A, 2Aa, 2Ac, 2Ae trunk
2, 2a, 2c, 2d trunk body
2I, 2Ic trunk body inner space
3, 3a, 3b, 3c, 3d, 3e neutron shielding container
3at, 3bt, 3dt, 3ct first neutron shielding container
3am, 3bm, 3dm, 3em second neutron shielding container
3ct first neutron shielding unit
3cm second neutron shielding unit
3bn third neutron shielding container
3at1 neutron shielding container divided body
4, 4a, 4c inner tube
5 outer casing
6T first end plate
6B second end plate
7 heat transfer fin
8 neutron shielding body
8at, 8bt, 8dt first neutron shielding body
8am, 8dm second neutron shielding body
8bn third neutron shielding body
8ct first neutron shielding unit shielding body
8cm second neutron shielding unit shielding body
9T, 9A1, 9A2 thermal expansion absorbing layer
10, 10a, 10b, 10A, 10B key
10d trunnion
16, 16a, 16b, 16c bottom structure
16p bottom plate
16t, 16at, 16bt, 16ct cylindrical member
17, 17c flange portion
20 sealing member
21 key groove
21a keyhole
30C cell
30, 30a basket
31, 31a square pipe
32, 33, 34 plate-like member

### BEST MODE(S) FOR CARRYING OUT THE INVENTION

The present invention will now be described in detail with reference to the drawings. However, the present invention is not limited by the following embodiments. Constituent elements according to the embodiments below include elements that can be easily assumed by a person skilled in the art, elements being substantially the same as those elements, and elements that fall within a so-called range of equivalents.

A radioactive substance storage container according to the present embodiment is a bottomed container and includes: a metal trunk body for storing radioactive substances such as recycled fuel therein; a neutron shielding container that includes an inner member in a cylindrical shape attached to the trunk body, an outer member in a cylindrical shape disposed outside the inner member, and heat transfer members that connects the inner member and the outer member; and a neutron shielding body disposed in a space surrounded by the inner member, the outer member, and the heat transfer members of the neutron shielding container.

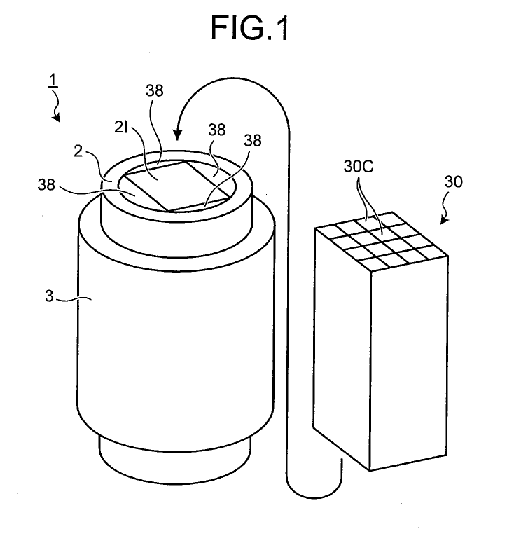

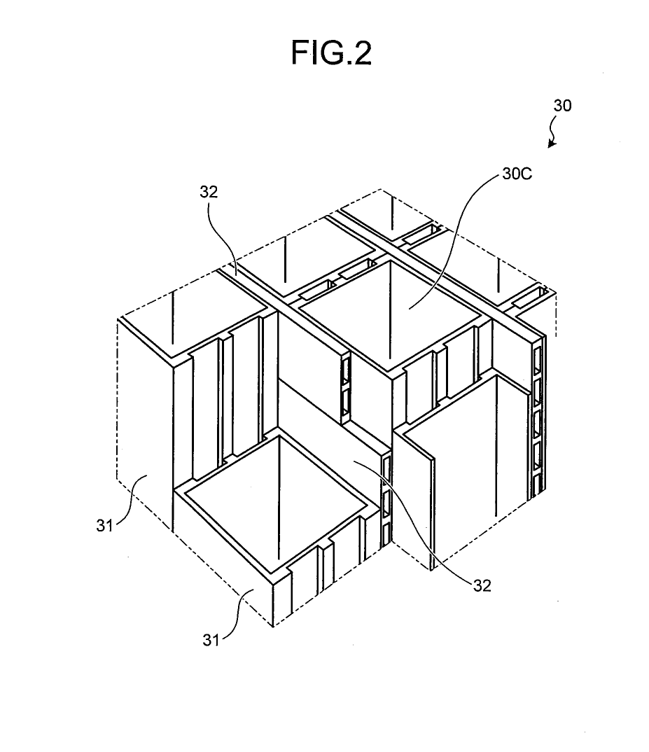

FIG. 1 is a schematic of an overall configuration of the radioactive substance storage container according to the present embodiment. FIG. 2 is a perspective view of an example of a basket of the radioactive substance storage container according to the present embodiment. This radioactive substance storage container 1 stores therein recycled fuel that is a fuel that has been used for nuclear power generation, in other words, radioactive substances, and is used for transportation and storage. In the present embodiment, a radioactive substance storage container that stores therein recycled fuel as an example of radioactive substances is described. However, the radioactive substances that can be stored in the radioactive substance storage container 1 of the present embodiment are not limited thereto. The radioactive substance storage container 1 includes a trunk body 2 that is a container with a bottom, and a neutron shielding container 3 attached outside the trunk body 2.

The trunk body 2 includes a trunk in a cylindrical shape and a bottom provided at one end of the trunk. A space (trunk body inner space, may be referred to as cavity) 2I formed by the trunk and the bottom is a space in which recycled fuel, which is a radioactive substance, is stored. The recycled fuel is contained in a cell 30C of a basket 30 having a plurality of grid cells 30C. The basket 30 that contains recycled fuel is stored in the trunk body inner space 2I.

The trunk body 2 has a function to shield gamma rays from the recycled fuel stored in the trunk body inner space 2I. The neutron shielding container 3 incorporates a neutron shielding body for shielding neutrons. Spacers 38 are disposed between the trunk body inner space 2I and the basket 30. The spacers 38 transfer decay heat from the recycled fuel contained in the basket 30 to the trunk body 2. The decay heat is released to the atmosphere through the trunk body 2 and the neutron shielding container 3.

As shown in FIG. 2, for example, the basket 30 is made by assembling square pipes 31 and plate-like members 32, and inner sides of the square pipes 31 form the cell 30C in which recycled fuel is stored. The square pipes 31 are pipes whose cross-sectional shape perpendicular to the longitudinal direction is a square, and have a plurality of protrusions outside the sides facing each other. A square pipe array is formed by bringing the protrusions of the square pipes 31 in contact with each other to be arranged in a straight line. Each of the plate-like members 32 is a pipe that has consecutive hollows in the cross section perpendicular to the longitudinal direction. The short ends of the plate-like members 32 of the cross section perpendicular to the longitudinal direction are brought in contact with each other and stacked, and the plate-like members 32 are disposed between the square pipe arrays arranged in a straight line.

The square pipes 31 and the plate-like members 32 both have a neutron shielding function. Accordingly, for example, the square pipes 31 and the plate-like members 32 are made of aluminum to which boron (B) or a boron compound is added, or an aluminum alloy to which the boron (B) or the boron compound is added. The boron (B) or the boron compound includes (B¹⁰) having a neutron shielding function. Boron can be added to aluminum or aluminum alloy by being dissolved together with a base material of aluminum or the aluminum alloy, or by mixing a mixture of boron powder and aluminum or aluminum alloy powder using a mixer or by carrying out mechanical alloying thereon. In the present embodiment, the square pipes 31 and the plate-like members 32 are manufactured by extruding a billet of aluminum to which boron or boron compound is added that is produced in this manner, or of aluminum alloy to which boron or boron compound is added that is produced in this manner, using porthole dies or the like. The structure of the radioactive substance storage container 1 according to the present embodiment will now be described.

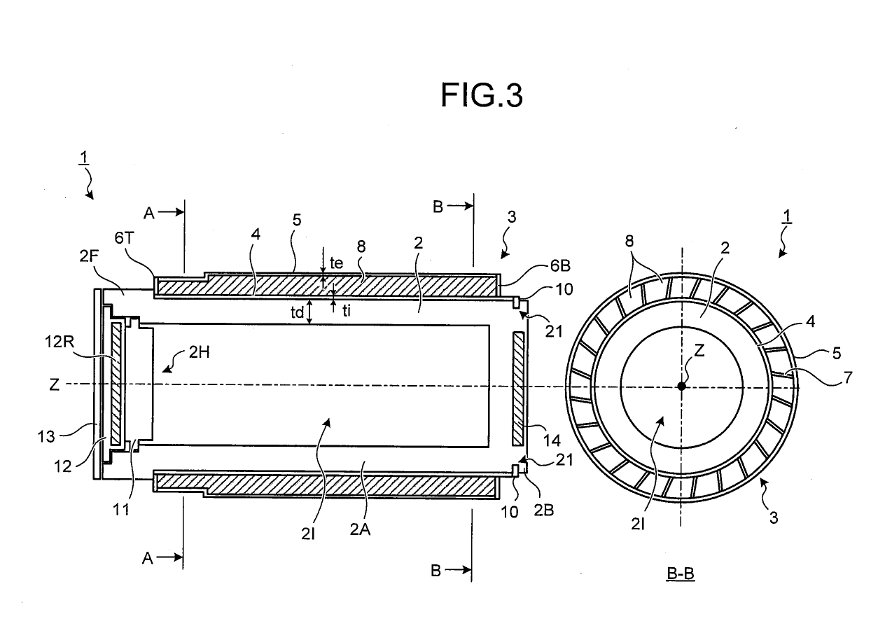

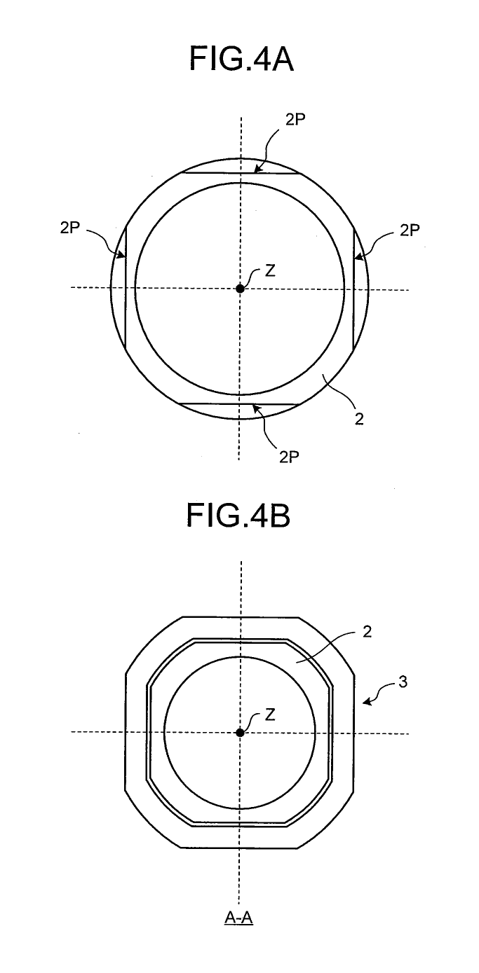

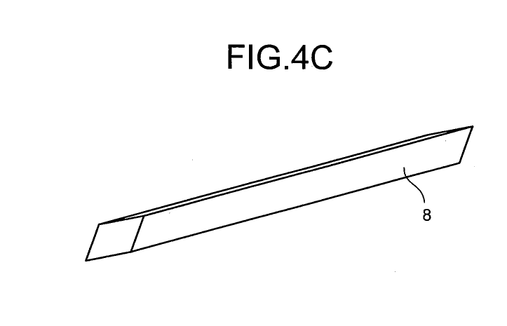

FIG. 3 is sectional views of the radioactive substance storage container according to the present embodiment, cut along a plane that passes through an axis of the radioactive substance storage container according to the present embodiment, and a plane perpendicular to the axis. FIG. 4A is a fragmentary view taken along the line A-A in FIG. 3, depicting a state in which the neutron shielding container according to the present embodiment is not attached. FIG. 4B is a fragmentary view taken along the line A-A in FIG. 3, depicting a state in which the neutron shielding container according to the present embodiment is attached. FIG. 4C is a perspective view of the neutron shielding body included in the neutron shielding container according to the present embodiment. FIG. 5 is a perspective view depicting a state in which the radioactive substance storage container according to the present embodiment is disassembled into a trunk body and a neutron shielding container.

The trunk body 2 of the radioactive substance storage container 1 is a bottomed container including a trunk 2A in a cylindrical shape and a bottom 2B provided at one end of the trunk 2A. The trunk body inner space 2I is formed by the trunk 2A and the bottom 2B. A neutron shielding body 14 is provided at the bottom 2B. The neutron shielding body 14 is similar to a neutron shielding body 8 in the neutron shielding container 3. In the present embodiment, the inner shape and the outer shape of the trunk body 2 in the cross section perpendicular to a center axis Z of the radioactive substance storage container 1 are circular. However, the inner shape and the outer shape of the trunk body 2 are not limited thereto.

An opening 2H is provided at the opposite end from the bottom 2B of the trunk 2A. The basket 30 shown in FIG. 1 is inserted into the trunk body inner space 2I from the opening. The basket 30 contains recycled fuel, and a primary lid 11, a secondary lid 12, and a tertiary lid 13 are attached to the opening 2H in this order, thereby sealing the trunk body inner space 2I.

In the trunk body 2, a flange portion 2F is provided on the trunk 2A at the side of the opening 2H, to attach the primary lid 11, the secondary lid 12, and the tertiary lid 13. The diameter of the flange portion 2F is larger than that of the trunk 2A, and the flange portion 2F extends out from the trunk 2A. Accordingly, a portion between the flange portion 2F and the trunk 2A is formed in a stair-like shape. The inside of the flange portion 2F is formed in a stair-like shape, to attach the primary lid 11, the secondary lid 12, and the tertiary lid 13. The number of lids is three at maximum. In the present embodiment, a neutron shielding body 12R is disposed inside the secondary lid 12. The neutron shielding body 12R is similar to the neutron shielding body 8 in the neutron shielding container 3. The primary lid 11 or the tertiary lid 13 may also include a neutron shielding body.

The trunk body 2 has a function to shield gamma rays from the recycled fuel stored in the trunk body inner space 2I. In the present embodiment, the trunk body 2 is made of cast iron (such as spheroidal graphite cast iron). Because the trunk body 2 occupies most of the mass of the radioactive substance storage container 1, reduction in the manufacturing cost of the trunk body 2 largely contributes to the reduction of the manufacturing cost of the radioactive substance storage container 1. Accordingly, because the trunk body 2 can be relatively easily manufactured by casting in which iron is cast in a cast mold, the manufacturing cost of the radioactive substance storage container 1 can be reduced. Consequently, it is possible to provide an inexpensive radioactive substance storage container 1.

The cast iron, due to its nature, unlike steel or stainless steel, cannot be welded as a structural member in which the same strength as that of the base material is required. Accordingly, a structure such as heat transfer fins cannot be attached to the outer periphery of the trunk body 2 made of cast iron by welding. In the present embodiment, the neutron shielding container 3 having a neutron shielding function is separately prepared from the trunk body 2, and the radioactive substance storage container 1 is formed by attaching the neutron shielding container 3 to the trunk body 2 having a gamma ray shielding function. In this manner, in the present embodiment, the radioactive substance storage container 1 is formed by dividing the functions between the trunk body 2 having a gamma ray shielding function, and the neutron shielding container 3 having a neutron shielding function.

The trunk body 2 made of cast iron and just finished into a predetermined size by machining has micro flaws and dents on the surface. Accordingly, anti-corrosion treatment applied on the radioactive substance storage container 1 is required when the radioactive substance storage container 1 is immersed into a fuel storage pool, to store recycled fuel in the radioactive substance storing container 1. Because the micro flows and dents on the surface of the trunk body 2 make decontamination difficult, they need to be filled up. Consequently, it is preferable to provide a coating layer on the surface of the trunk body inner space 2I of the trunk body 2.

To form such a coating layer, a method of forming a coating film over the surface of the container by coating is known. By using this method, the coating layer can be formed inexpensively. The coating layer can also be formed by thermally spraying a material mainly containing a nickel component, or with an electroplated layer. In this manner, the heat transfer between the surface of the trunk body inner space 2I and the basket 30 is facilitated. With the thermal spraying, it is difficult to produce a layer without any gap. Accordingly, it is preferable to also perform a hole sealing process using resin. When the thermal spraying is used, the coating layer may be formed of a material that may be a sacrificial electrode. When the electroplating is used, the plating layer needs to be thick enough so that the flaws and dents are filled up. Assuming that the coating layers are damaged by coming into contact with the basket while being transported or moved, the thickness of the layer is set so that the damage can be reduced to a minimum.

In the electroplating, it is preferable that a nickel plated coating layer is formed, in terms of making anti-corrosion treatment be performed easily on the surface of the trunk body inner space 2I, and facilitating the heat transfer between the trunk body inner space 2I and the basket 30. When the nickel plating is performed, it is important to form a thick layer so that the flaws and dents on the surface of the trunk body inner space 2I are filled up. Accordingly, the thickness of the layer, for example, is preferably equal to or more than 100 micrometers, and desirably equal to or more than 500 micrometers. In this manner, the thickness of the coating layer required in the trunk body inner space 2I can be provided without fail.

As shown in FIGS. 3, 4, and 5, the neutron shielding container 3 is a cylindrical structure, and attached to the outer periphery of the trunk body 2 by an interference fit. In other words, the outer peripheral length of the trunk body 2 is formed longer than the inner peripheral length of the neutron shielding container 3, and to assemble the trunk body 2 and the neutron shielding container 3, the inner peripheral length of the neutron shielding container 3 is temporarily extended than the outer peripheral length of the trunk body 2, by increasing a temperature of the neutron shielding container 3 to be higher than the temperature of the trunk body 2. In this state, as shown in FIG. 5, the neutron shielding container 3 is attached to the trunk body 2. When the temperatures of the neutron shielding container 3 and the trunk body 2 become approximately the same, the outer peripheral length of the trunk body 2 becomes longer than the inner peripheral length of the neutron shielding container 3. Accordingly, the neutron shielding container 3 is extended in the circumferential direction by the trunk body 2, thereby being fixed to the trunk body 2.

In this manner, the neutron shielding container 3 is attached to the trunk body 2 by an interference fit, and the neutron shielding container 3 and the trunk body 2 are not connected by cast bonding, welding, or the like. Accordingly, upon dismantling the radioactive substance storage container 1, the neutron shielding container 3 can be easily removed from the trunk body 2. As a result, the radioactive substance storage container 1 can be easily dismantled.

The interference fit, for example, includes a shrink fit in which the neutron shielding container 3 is attached to the trunk body 2 by heating the neutron shielding container 3 to have temperature higher than that of the trunk body 2, or a cold shrink fit in which the neutron shielding container 3 is attached to the trunk body 2 by cooling the trunk body 2 to have temperature lower than that of the neutron shielding container 3. In this manner, by attaching the neutron shielding container 3 to the trunk body 2 by an interference fit, it is possible to prevent an unstable structure produced when a fastening unit such as a bolt is used. Accordingly, a robust radioactive substance storage container 1 can be obtained. Consequently, the reliability in transportation of the radioactive substance storage container 1 and the reliability in long-term storage over many decades can also be improved.

As shown in FIGS. 3 and 4, the outer shell of the neutron shielding container 3 is formed by an inner tube 4 that is an inner member in a cylindrical shape, an outer casing 5 that is an outer member in a cylindrical shape disposed outside the inner tube 4, a first end plate 6T that seals the end of the inner tube 4 and the end of the outer casing 5 of the radioactive substance storage container 1 at the side of the flange portion 2F, and a second end plate 6B that seals the end of the inner tube 4 and the end of the outer casing 5 of the radioactive substance storage container 1 at the side of the bottom 2B. The inner tube 4, the outer casing 5, the first end plate 6T, and the second end plate 6B are made of carbon steel and stainless steel. The inner tube 4, the outer casing 5, the first end plate 6T, and the second end plate 6B are connected, for example, by welding.

As shown in FIG. 3, a plurality of heat transfer fins 7 that is heat transfer members for transferring heat from the inner tube 4 to the outer casing 5 is disposed between the inner tube 4 and the outer casing 5, in the circumferential direction of the inner tube 4 and the outer casing 5. The heat transfer fins 7 are attached to the inner tube 4 and the outer casing 5 by welding. The heat transfer fins 7 are preferably made of a material having good heat conductivity such as copper or aluminum. However, the material of the heat transfer fins 7 is not limited thereto. For example, considering that the transfer fins 7 are welded to the inner tube 4 and the outer casing 5, the heat transfer fins 7 may be made of the same type of material as those of the inner tube 4 and the outer casing 5.

Among the members that form the neutron shielding container 3, materials for the inner tube 4, the outer casing 5, the first end plate 6T, and the second end plate 6B are preferably less likely to be activated. In this manner, the inner tube 4, the outer casing 5, the first end plate 6T and the second end plate 6B can be prevented from being activated, thereby allowing them to be easily recycled. A material less likely to be activated, for example, is a carbon steel that does not include elements likely to be activated, such as chrome (Cr), carbon (C), niobium (Nb), cobalt (Co), and aluminum (Al) as much as possible.

The neutron shielding body 8 is disposed in a space (neutron shielding body storage space) surrounded by the inner tube 4, the outer casing 5, and the heat transfer fins 7 adjacent to each other. The neutron shielding body 8 is made of a polymer material containing hydrogen, such as resin, polyurethane, epoxy resin, or silicon resin. By using the neutron shielding body 8 made of such materials, it is possible to absorb neutrons emitted from recycled fuel, thereby reducing the number of neutrons leaking outside the radioactive substance storage container 1 to be less than the regulation value. The neutron shielding body mixed with hydrogen storage alloy powder releases an extremely small amount of absorbed hydrogen even in a normal usage environment of the radioactive substance storage container, thereby increasing the pressure in the space in which the neutron shielding body is contained. When fire breaks out, the neutron shielding body mixed with hydrogen storage alloy powder may rapidly release hydrogen, and may rapidly increase the pressure in the outer casing. Accordingly, the neutron shielding body mixed with hydrogen storage alloy powder is not suitable as a neutron shielding body of the radioactive substance storage container.

In the present embodiment, as shown in FIG. 4C, the neutron shielding body 8 solidified by casting resin and the like into a mold in advance is disposed in the neutron shielding body storage space, and then the first end plate 6T or the second end plate 6B is attached to the inner tube 4 and the outer casing 5. The neutron shielding body 8 may be formed by pouring liquid resin and the like into the neutron shielding body storage space and solidifying the liquid resin. By disposing the neutron shielding body 8 solidified by pouring resin and the like into a mold in advance into the neutron shielding body storage space, the neutron shielding body 8 can be easily removed from the neutron shielding container 3, upon dismantling the radioactive substance storage container 1. Accordingly, the radioactive substance storage container 1 can be easily dismantled.

A release layer that prevents the neutron shielding body 8 from being deposited is preferably disposed in the neutron shielding body storage space. The main component of the neutron shielding body 8 is a resin material such as epoxy resin or polyurethane. Because the epoxy resin in particular is also used as an adhesive, the neutron shielding body 8 adhering to the members that form the neutron shielding container 3 needs to be peeled off therefrom upon dismantling. However, because the surface area of the neutron shielding body storage space of one radioactive substance storage container 1 is approximately 80 square meters, it is not easy to peel off the neutron shielding body 8 therefrom.

The epoxy resin does not easily deform, and when a cutting tool is used to cut the neutron shielding body 8, the cutting tool wears rapidly by flame retardant and neutron absorbing components (typically, boron carbide) included in the neutron shielding body 8. In addition, because the neutron shielding body 8 scatters, the neutron shielding body 8 cannot be dismantled efficiently. With a cutting torch that uses heat, it is difficult to perform the cutting operation, due to a large amount of flame retardant included in the neutron shielding body 8. Considering the risk that the epoxy resin, which is the main component of the neutron shielding body 8, may burn, the neutron shielding body 8 cannot be dismantled in an open space.

In the present embodiment, the metal and the neutron shielding body are separated by the release layer that prevents the neutron shielding body 8 from adhering. Accordingly, the neutron shielding body 8 can be easily removed from the neutron shielding container 3. In the present embodiment, the radioactive substance storage container 1 is formed by the trunk body 2 and the neutron shielding container 3. Accordingly, the fitting between the trunk body 2 and the neutron shielding container 3 can be released, by cutting a part of the neutron shielding container 3. Consequently, the neutron shielding body 8 can be easily removed, by removing the neutron shielding container 3 from the trunk body 2, and cutting a metal portion of the neutron shielding container 3. This is because the neutron shielding body 8 is prevented from adhering to the metal portion by the release layer that prevents the neutron shielding body 8 from adhering. The release layer that prevents the neutron shielding body 8 from adhering may be, for example, fluorine resin, silicon resin, and surface-active agent.

The inner tube 4 comes in close contact with the trunk body 2 by being attached to the trunk body 2 by an interference fit. The heat from the trunk body 2 is transferred to the outer casing 5 that is in contact with the outside air through the heat transfer fins 7. Accordingly, it is preferable that the inner tube 4 and the trunk body 2 come in close contact with each other with a gap as small as possible. Consequently, the inner shape of the inner tube 4 matches the outer shape of the trunk body 2. By attaching the inner tube 4 to the trunk body 2 in this manner, the gap therebetween can be reduced.

Hoisting attachments called trunnions are attached to the radioactive substance storage container 1 at the side of the flange portion 2F. To attach the trunnions, for example, as shown in FIG. 4A, trunnion mounts 2P may be provided on a part of the flange portion 2F of the trunk body 2. Each of the trunnion mounts 2P is formed by making a part of the trunk body 2 in which the cross section perpendicular to the center axis Z of the radioactive substance storage container 1 is a circular in a plane shape. The trunnions are attached to face each other on a straight line that passes through the center axis Z of the radioactive substance storage container 1. In the present embodiment, two pairs, in other words, four trunnions are attached to the trunk body 2.

The portions where the trunnion mounts 2P are formed on the trunk body 2 are non-circular in shape. Accordingly, the inner shape of the inner tube 4 of the neutron shielding container 3 is also formed with plane surfaces and curved surfaces to match the outer shape of the portion. At the portions where the trunnion mounts 2P of the trunk body 2 are formed, the size in the radial direction of the portions where the trunnion mounts 2P are formed is smaller than the cross section cut along the B-B line in FIG. 3. Consequently, to form the trunnion mounts 2P on the trunk body 2, the neutron shielding container 3 is divided in the direction of the center axis Z of the radioactive substance storage container 1, and the neutron shielding container 3 is separated into portions where the trunnion mounts 2P are formed and portions where the trunnion mounts 2P are not formed. As described above, the neutron shielding container 3 disposed on the trunnion mounts 2P is divided into the circumferential direction, and attached to the trunk body 2. The trunnions may be attached to the trunk body without providing the trunnion mounts 2P. In this case, the shape of the portions where the trunnion mounts 2P are formed on the trunk body 2 are the same as the other portions (circular in the present embodiment).

The trunk body 2 has a thickness of a few tens of centimeters, to shield gamma rays emitted from recycled fuel stored in the trunk body inner space 2I. The neutron shielding container 3 is also required to have the gamma ray shielding function to some extent, but the required gamma ray shielding function is smaller than that required for the trunk body 2. Accordingly, a thickness ti of the inner tube 4 and a thickness te of the outer casing 5 may be smaller than a thickness td of the trunk body 2, thereby reducing the weight of the neutron shielding container 3.

When the materials used to form the radioactive substance storage container 1 are assumed to be recycled, the intensity of radiation and the type of radiation of the radioactive substance contained in the radioactive substance storage container 1 must be taken into account. In other words, the extent to which the materials of the radioactive substance storage container 1 are activated by radiation is important in recycling the materials of the radioactive substance storage container 1.

The metals of the structures within a range where recycling is difficult due to radiation may be formed by casting, and the metals of the structures within a range where radiation exposure is acceptable may be recycled as a steel material. In this case, the thickness td of the trunk body 2 and the thickness ti of the inner tube 4 of the neutron shielding container 3 are preferably determined within a range likely to be activated and within a range less likely to be activated.

As described above, the inner tube 4 is attached to the trunk body 2 by an interference fit, and comes in close contact with the trunk body 2, thereby requiring a high dimensional accuracy. Consequently, the thickness ti of the inner tube 4 is preferably larger than the thickness te of the outer casing 5. In this manner, it is possible to prevent a space from forming between the inner tube 4 and the trunk body 2, while ensuring high dimensional accuracy of the inner tube 4. Because the heat transfer fins 7, the first end plate 6T, and the like are welded to the inner tube 4, distortion due to the heat upon welding needs to be prevented as much as possible. To match the inner shape of the inner tube 4 with the outer shape of the trunk body 2, the inside of the inner tube 4 needs to be machined by cutting and the like, after the neutron shielding container 3 is assembled. Accordingly, the inner tube 4 needs to have a thickness to some extent, to prevent heat strain and to ensure a cutting allowance and rigidity for cutting operation.

To prevent the neutron shielding container 3 from shifting in the direction of the center axis Z of the radioactive substance storage container 1, a key 10 that is an engaging member is attached to the bottom 2B of the trunk body 2. The key 10 is fitted into a key groove 21 formed at the bottom 2B of the trunk body 2 and brought in contact with the end of the inner tube 4 of the neutron shielding container 3 attached to the trunk body 2, by being protruded from the outer surface of the bottom 2B. In this manner, the shift of the neutron shielding container 3 can be prevented. If the neutron shielding container 3 is fixed by the key 10, the shift between the neutron shielding container 3 and the trunk body 2 can be prevented, even if a stress generated between the neutron shielding container 3 and the trunk body 2 is reduced, when the neutron shielding container 3 is attached to the trunk body 2 by a shrink fit or a cold shrink fit. If the neutron shielding container 3 is fixed by the key 10, the stress generated between the neutron shielding container 3 and the trunk body 2 when the neutron shielding container 3 is attached to the trunk body 2 can be reduced. Accordingly, it is also possible to easily perform the operation of disassembling the radioactive substance storage container 1 into the inner tube 4 and the neutron shielding container 3.

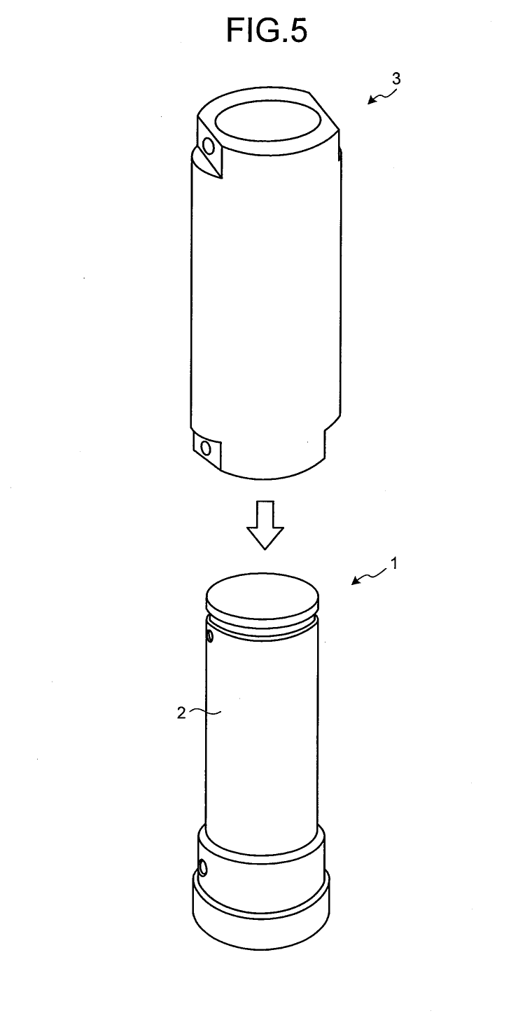

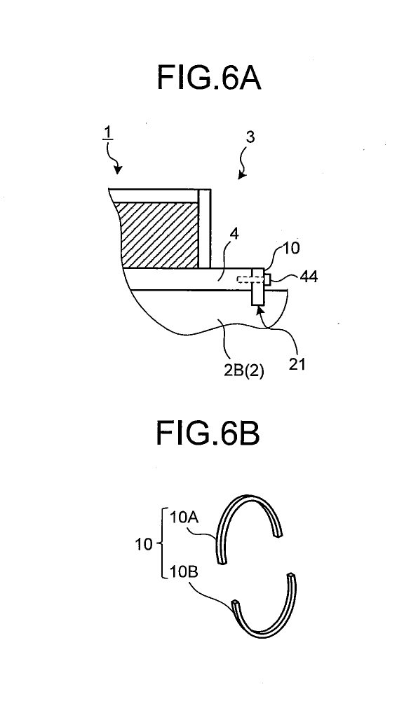

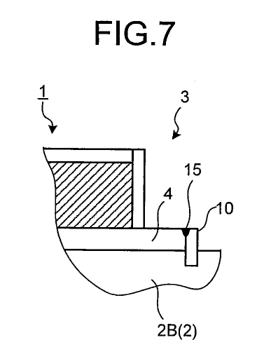

FIG. 6A is a schematic for explaining an example of a structure for fixing a key. FIG. 6B is a schematic for explaining an example of a key. FIGS. 7, 8A, and 8B are schematics for explaining other examples of a structure for fixing a key. The key 10 is made of a ring-shaped metal (such as carbon steel) member, and the ring-shaped key 10 is heated and fitted to the bottom 2B of the trunk body 2. When the temperature of the key 10 is reduced, the key 10 shrinks, thereby fitting the key 10 into the key groove 21. Between the key 10 and the neutron and the neutron shielding container 3, as shown in FIG. 6A, the key 10 and the inner tube 4 of the neutron shielding container 3 are fixed with a bolt 44. Because the key 10 can be easily placed outside the radioactive substance storage container 1 at normal temperature, it is easy to assemble and dismantle the radioactive substance storage container 1.

In the example shown in FIG. 6B, as the key 10, for example, keys 10A and 10B are used that are prepared by dividing a circle in the circumferential direction (halved in the present embodiment). The keys 10A and 10B are attached to the key groove 21 shown in FIG. 6A, so as to sandwich the bottom 2B of the trunk body 2 therebetween. The key 10 and the neutron shielding container 3 are then fixed, with the bolt 44. In this manner, the key 10 and the neutron shielding container 3 can be easily fixed without fail. Even if the key 10 made of a ring-shaped metal cannot be attached by using a shrink fit, the key 10 can be easily attached to the key groove 21 by dividing the key 10 into pieces.

As shown in FIG. 7, the key 10 and the inner tube 4 of the neutron shielding container 3 may also be connected by welding. The key 10 and the inner tube 4 are connected by welding at a connection portion 15. In this manner, when the key 10 and the inner tube 4 are fixed by welding, the key 10 and the inner tube 4 can be fixed without fail. Accordingly, it is possible to reduce the risk of the radioactive substance storage container 1 contaminating a fuel storage pool and improve the reliability in transportation of the radioactive substance storage container 1.

In FIGS. 8A and 8B, a plurality of keys 10a are disposed apart in the circumferential direction of the trunk body 2. As shown in FIG. 8B, each of the keys 10a is a rod-like shaped member (such as a round bar), and inserted into a keyhole 21a opened in the inner tube 4 of the neutron shielding container 3 and the bottom 2B of the trunk body 2, in the radial direction of the trunk body 2. A plurality of keyholes 21a are opened in the inner tube 4 of the neutron shielding container 3 and the bottom 2B of the trunk body 2, in the circumferential direction of the trunk body 2.

The shapes of each of the keys 10a and the keyholes 21a, for example, may be rectangular, but the keyhole 21a can be easily opened, if the shapes of the key 10a and the keyhole 21a are circular. The inner diameter of the key 10a becomes smaller towards the center of the bottom 2B of the trunk body 2 (center axis Z of the radioactive substance storage container 1). In this manner, when the key 10a is driven into the keyhole 21a, the key 10a is fixed to the keyhole 21a, thereby preventing the key 10a from falling out. In this manner, by disposing the keys 10a apart from each other in the circumferential direction of the trunk body 2, the shifting movement between the trunk body 2 and the neutron shielding container 3 can be received by the keys 10a disposed apart from each other in substantially uniform load.

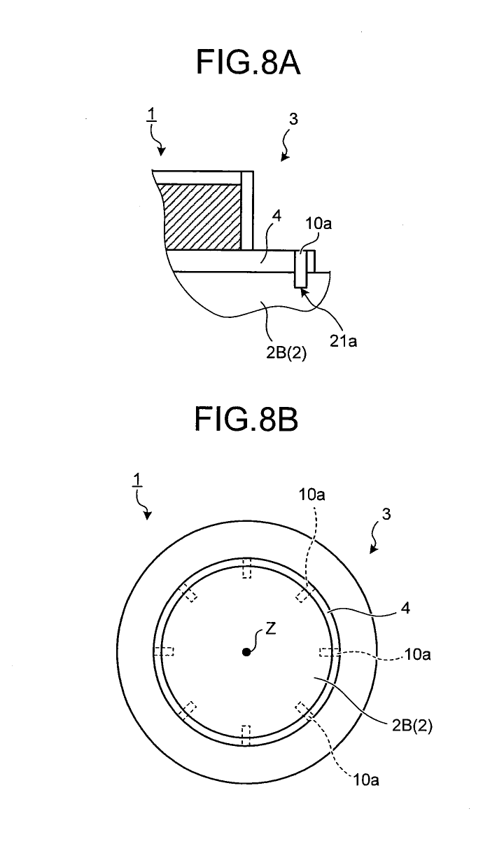

FIGS. 9A and 9B are schematics for explaining an alternative structure of a key. In the example shown in FIG. 9A, the key 10 is attached to the bottom 2B of the trunk body 2, and the end of the inner tube 4 of the neutron shielding container 3 is fixed by the key 10. In addition, the inner tube 4 of the neutron shielding container 3 and the trunk 2A of the trunk body 2 are fixed by a key 10b. In other words, the key 10b is disposed at a portion covered by the inner tube 4 of the neutron shielding container 3. In the example shown in FIG. 9B, the key 10 is attached to the bottom 2B of the trunk body 2, and the end of the inner tube 4 of the neutron shielding container 3 is fixed by the key 10. In addition, a trunnion 10d is used as an engaging member to fix the neutron shielding container 3 to the trunk body 2. By disposing the key in this manner, the load applied to the key due to a difference between the thermal elongation of the trunk body 2 and the thermal elongation of the inner tube 4 can be dispersed.

A plurality of trunnions 10d are arranged apart from each other in the circumferential direction of the trunk body 2, and the trunnions 10d are fixed to a trunk 2Ac of the trunk body 2 while penetrating through the neutron shielding container 3. Accordingly, the trunnions 10d can be used as engaging units to fix the neutron shielding container 3 to the trunk body 2. The cross section of each of the trunnions 10d is sufficiently large, and the trunnions 10d are disposed around the entire periphery of the trunk body 2 at substantially regular intervals. Consequently, when the trunnions 10d are used as engaging members, the neutron shielding container 3 can be fixed to the trunk body 2 without fail. Because the trunnion 10d is fixed to the trunk body 2 by a fastening unit such as a screw, the removal thereof is also easy. Because the neutron shielding container 3 can be dismantled by just removing the trunnions 10d, the radioactive substance storage container 1 can be easily dismantled.

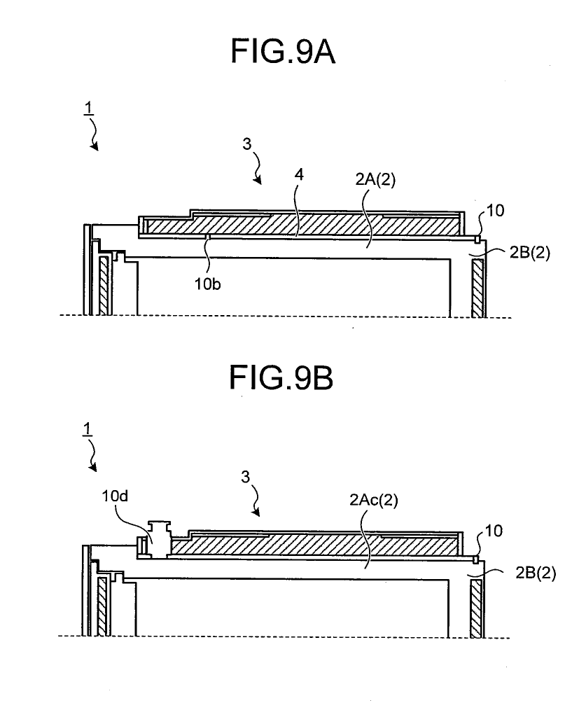

FIGS. 10A and 10B are schematics for explaining an example of a sealing structure between the neutron shielding container and the trunk body. In the example shown in FIG. 10A, the flange portion 2F of the trunk body 2 has a recess 2Fs in which a sealing member is disposed. The recess 2Fs is formed at a portion where the flange portion 2F and the first end plate 6T of the neutron shielding container 3 come in contact with each other in the circumferential direction of the flange portion 2F. A sealing member 20 such as resin is disposed in the recess 2Fs. The recess to which the sealing member 20 is disposed may be formed at the first end plate 6T of the neutron shielding container 3.

In FIG. 10B, a recess 4s to which a sealing member is disposed is formed at the end of the inner tube 4 of the neutron shielding container 3, at the side of the bottom B of the trunk body 2. The recess 4s is formed in the circumferential direction of the inner tube 4. The sealing member 20 such as resin is disposed in the recess 4s. The recess to which the sealing member 20 is disposed may be formed at the bottom 2B of the trunk body 2.

Upon storing recycled fuel in the radioactive substance storage container 1, the radioactive substance storage container 1 is immersed into a fuel storage pool. Therefore, if a space exists between the trunk body 2 and the neutron shielding container 3, the water in the fuel storage pool may enter the space. As a result, the trunk body 2 and the neutron shielding container 3 may be eroded. Accordingly, as described above, an area of the portion where the trunk body 2 and the neutron shielding container 3 come in contact with each other that can be seen from outside is sealed. Consequently, it is possible to prevent water from entering the space, for example, when the radioactive substance storage container 1 is immersed in the fuel storage pool or when the radioactive substance storage container 1 is cleaned by washing with water and the like.

When the sealing member 20 is made of resin, if the sealing member 20 is protruded from the surface of the radioactive substance storage container 1, the sealing member 20 may be damaged while the radioactive substance storage container 1 is being handled. Accordingly, as described above, it is preferable to provide the recesses 2Fs and 4s to receive the sealing member 20, at least at one of the radioactive substance storage container 1 and the neutron shielding container 3. In this manner, an amount of the sealing member 20 protruding from the surface of the radioactive substance storage container 1 can be reduced.

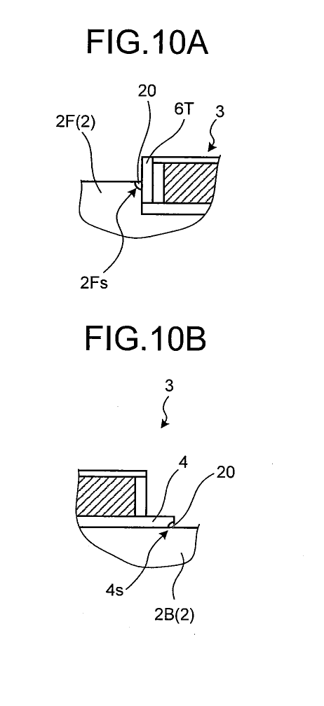

FIG. 11 is a schematic of a state in which the neutron shielding container is attached to the trunk body. To attach the neutron shielding container 3 to the trunk body 2, the space is provided therebetween by a shrink fit and a cold shrink fit. However, the sizes of the trunk body 2 and the neutron shielding container 3 are large (few meters) in the direction of the center axis Z of the radioactive substance storage container 1. Accordingly, upon attaching the neutron shielding container 3 to the trunk body 2, the trunk body 2 and the inner tube 4 of the neutron shielding container 3 come into contact with each other. At this time, if a difference between the hardness of the trunk body 2 and the hardness of the inner tube 4 is small, galling and tearing may occur. Consequently, a space may be left between the trunk body 2 and the inner tube 4, after the trunk body 2 and the inner tube 4 are being assembled.

Accordingly, the neutron shielding container 3 is attached to the trunk body 2, with a lubricating material interposed between the trunk body 2 and the inner tube 4 of the neutron shielding container 3. The lubricating material can reduce friction between the inner tube 4 and the trunk body 2, when the inner tube 4 and the trunk body 2 come in contact with each other, upon the operation of attaching the neutron shielding container 3 to the trunk body 2. Consequently, it is possible to smoothly assemble the trunk body 2 and the neutron shielding container 3. Because the trunk body 2 and the inner tube 4 of the neutron shielding container 3 can be attached to each other even with the temperature for the shrink fit reduced and only a narrow space provided therebetween. Therefore, it is also possible to prevent distortion and oxidation from occurring when the neutron shielding container 3 is heated.

After the neutron shielding container 3 is attached to the trunk body 2, the lubricating material is disposed in the space therebetween. Accordingly, heat transfer from the trunk body 2 to the neutron shielding container 3 is secured by the lubricating material. Thus, it is possible to prevent reduction of heat transfer performance due to a space between the trunk body 2 and the inner tube 4 of the neutron shielding container 3.

Consequently, the lubricating material preferably includes a heat conductor. As a result, the heat transfer performance from the trunk body 2 to the neutron shielding container 3 can further be improved. The heat conductor may be metal such as silver and copper, or carbon. If the lubricating material has fluidity to some extent, the effect of suppressing the friction between the trunk body 2 and the inner tube 4 of the neutron shielding container 3 is further improved. Further, because the lubricating material spreads evenly into the space between the trunk body 2 and the inner tube 4 of the neutron shielding container 3, the reduction of heat transfer performance can be more effectively prevented. The lubricating material may be the above-described paste including a heat conductor, in other words, a metal paste such as a copper paste or a silver paste, or a carbon paste. It is also possible to use an adhering member or a spray agent including a heat conductor.

When the metal paste, the carbon paste, or the like is used as the lubricating material, if the inner tube 4 and the trunk body 2 come in contact with each other upon attaching the neutron shielding container 3 to the trunk body 2, the lubricating material may be accumulated at the end of the inner tube 4, and may not enter the gap between the inner tube 4 and the trunk body 2. Consequently, in the present embodiment, a lubricating material reservoir is formed by providing a recess 2As on the outer surface of the trunk 2A of the trunk body 2 in the circumferential direction of the trunk 2A. This allows the lubricating material to be inserted between the inner tube 4 and the trunk body 2. The recess 2As is preferably provided in plurality in the direction of the center axis Z of the radioactive substance storage container 1. In this manner, it is possible to prevent uneven distribution of the lubricating material in the direction of the center axis Z of the radioactive substance storage container 1.

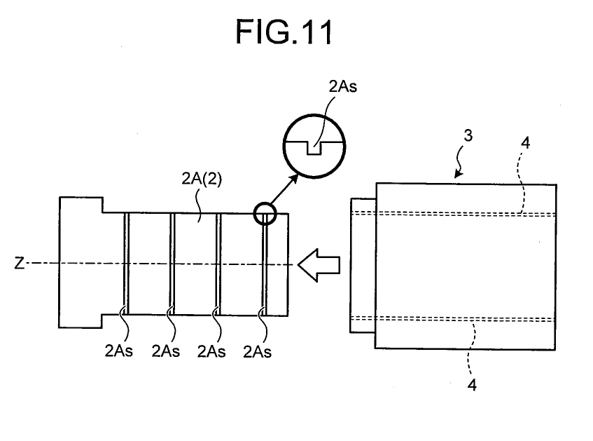

FIGS. 12A to 12D are schematics for explaining a structure of the bottom of the radioactive substance storage container according to the present embodiment. The radioactive substance storage container 1 is formed by assembling the neutron shielding container 3 to the trunk body 2. Accordingly, compared with a configuration in which a structure having a neutron shielding function is directly attached to the trunk body, the outer diameter of the trunk body 2 is reduced as much as the thickness of the inner tube 4 of the neutron shielding container 3. As a result, the outer diameter of the bottom of the trunk body 2 is also reduced, thereby making the radioactive substance storage container 1 likely to be tipped over. Consequently, a large load may be applied to a fixture that connects a lower trunnion used to prevent the radioactive substance storage container 1 from being tipped over and a storage floor on which the radioactive substance storage container 1 is placed. To solve the problem, the outer diameter of the bottom 2B of the trunk body 2 is preferably large to improve the resistance of the radioactive substance storage container 1 from being tipped over.

Because the trunk body 2 of the radioactive substance, storage container 1 is made of cast iron, a method of increasing the outer diameter of the bottom 2B by connecting a structure to the bottom 2B of the trunk body 2 by welding, cannot be adopted. Here, a bottom structure 16 fitted to the side surface of the bottom 2B of the trunk body 2 and in which the neutron shielding body 14 is stored is attached to the bottom 2B.

The bottom structure 16 includes a cylindrical member 16t and a bottom plate 16p provided at the end of the cylindrical member 16t. One end of the cylindrical member 16t is attached to the bottom 2B of the trunk body 2. The bottom plate 16p is attached to the end of the cylindrical member 16t at the side opposite from the side of the bottom 2B. An opening is provided at the end of the bottom 2B of the cylindrical member 16t, and the neutron shielding body 14 is disposed in a space surrounded by the cylindrical member 16t and the bottom plate 16p through the opening. The opening may be sealed by a plate and the like, after the neutron shielding body 14 is stored in the bottom structure 16.

The outer diameter of the cylindrical member 16t of the bottom structure 16 is as large as the outer diameter of the inner tube 4 of the neutron shielding container 3. The cylindrical member 16t and the inner tube 4 are connected by connecting means, such as welding. In this manner, the outer diameter of the bottom 2B of the trunk body 2 can be increased to be as large as the outer diameter of the inner tube 4 of the neutron shielding container 3. Accordingly, it is possible to improve the resistance of the radioactive substance storage container 1 from being tipped over. Upon dismantling the radioactive substance storage container 1 after the task is completed, it is also possible to easily dismantle the structure in a range less likely to be activated (the cylindrical member 16t provided at the bottom 2B of the trunk body 2). Accordingly, the structure can be easily recycled. Because the cylindrical member 16t of the bottom structure 16 is fitted to the side surface of the bottom 2B of the trunk body 2, the inside of the bottom structure 16 is sealed. In this manner, it is possible to prevent water from entering the bottom structure 16, thereby reducing the risk of eroding the inside of the bottom structure 16.

A bottom structure 16a shown in FIG. 12B includes a cylindrical member 16at and a bottom plate 16ap provided at the end of the cylindrical member 16at. The bottom of the radioactive substance storage container shown in FIG. 12B has a protrusion 2Bat on the surface facing the bottom structure 16a at a bottom 2Ba of the trunk body 2. A recess 16s formed at the end facing the bottom 2Ba of the cylindrical member 16at of the bottom structure 16a and the protrusion 2Bat are fitted to each other. Consequently, the bottom structure 16a is fixed to the bottom 2Ba of the trunk body 2 without fail. If the radioactive substance storage container 1 is dropped and the bottom structure 16a collides with the ground, the shift or separation between the bottom 2Ba and the bottom structure 16a can be prevented, because the recess 16s and the protrusion 2Bat are meshed with each other. In this manner, with the present structure, a robust radioactive substance storage container 1 can be obtained.

A bottom structure 16b shown in FIG. 12C includes a cylindrical member 16bt and a bottom plate 16bp provided at the end of the cylindrical member 16bt. In the radioactive substance storage container 1 shown in FIG. 12C, the cylindrical member 16bt of the bottom structure 16b includes a flange portion 17 that is a portion coming in contact with the inner tube 4 of the neutron shielding container 3 extending in the radial direction of the cylindrical member 16bt. Because an area at which the second end plate 6B of the neutron shielding container 3 and the bottom structure 16b come in contact with each other is increased with the flange portion 17, a robust radioactive substance storage container 1 can be obtained.

A bottom structure 16c shown in FIG. 12D includes a cylindrical member 16ct and a bottom plate 16cp provided at the end of the cylindrical member 16ct. In the radioactive substance storage container 1 shown in FIG. 12D, the cylindrical member 16ct of the bottom structure 16c includes a flange portion 17c that is a portion coming in contact with the inner tube 4 of the neutron shielding container 3 further extending in the radial direction of the cylindrical member 16ct, compared with that of the cylindrical member 16bt shown in FIG. 12C. The flange portion 17c extends out to reach the outer casing 5 of the neutron shielding container 3 to serve as an end plate of the bottom 2B of the neutron shielding container 3. Accordingly, the second end plate 6B required for the neutron shielding container 3 shown in FIG. 12C is no longer required, thereby reducing the cost and weight, because the number of parts are decreased.

In a state in which recycled fuel is stored in the radioactive substance storage container 1, the thermal elongation of the neutron shielding container 3 is preferably equal to or less than the thermal elongation of the trunk body 2. In this manner, even after the recycled fuel is stored in the radioactive substance storage container 1, a state in which the neutron shielding container 3 and the trunk body 2 are in close contact with each other can be provided without fail. Accordingly, the heat transfer from the trunk body 2 to the neutron shielding container 3 can also be provided without fail.

In this case, the thermal elongation of the neutron shielding container 3 is set so as not to be too small compared with the thermal elongation of the trunk body 2. In this manner, it is possible to prevent durability of the neutron shielding container 3 and the trunk body 2 from being lowered, resulting from the absolute value of the thermal elongation being too large.

An example of a method for manufacturing the radioactive substance storage container 1 will now be described.

### (First Example of Manufacturing Method)

(1) The trunk body 2 of the radioactive substance storage container 1 is manufactured by casting. In this case, the trunk body 2 is manufactured as a bottomed integral container in which the trunk 2A and the bottom 2B are integrally formed. Cast iron is used as a material for the trunk body 2.
(2) The outer surface of the trunk body 2 is machined into a predetermined shape by cutting, polishing, and the like, thereby achieving the required accuracy. At this time, as shown in FIG. 11, it is preferable to form a lubricating material reservoir by providing the recesses 2As at the outer surface of the trunk 2A of the trunk body 2 in the circumferential direction of the trunk 2A (the same in the following examples).
(3) The inner tube 4 having an inner shape matched with the outer shape of the trunk body 2 is manufactured. The outer casing 5 disposed outside the inner tube 4 is also manufactured. For example, the inner tube 4 and the outer casing 5 in cylindrical shapes are manufactured by connecting the ends of a bent steel plate by welding and the like.
(4) The heat transfer fins 7 are attached between the inner tube 4 and the outer casing 5 by connecting means, such as welding. At this time, at least one of the first end plate 6T and the second end plate 6B is also connected to the end of the inner tube 4 and the end of the outer casing 5. Then, to remove thermal stress, heat treatment such as annealing is performed on the structure after the welding.
(5) The neutron shielding body 8 in a liquid form is cast into a space formed by the inner tube 4, the outer casing 5, and the heat transfer fins 7. Alternatively, the neutron shielding, body 8 solidified and molded into the shape of the space in advance may be inserted into the space.
(6) When the neutron shielding body 8 is cast in, the cast opening is sealed. When the molded neutron shielding body 8 is inserted, an end plate different from the end plate already being fixed is attached.
(7) The neutron shielding container 3 is attached to the trunk body 2. In this case, the neutron shielding body 8 is already disposed in the neutron shielding container 3. Accordingly, a cold shrink fit in which the trunk body 2 is cooled is used. To attach the neutron shielding container 3 to the trunk body 2, it is preferable to interpose a lubricating material between the neutron shielding container 3 and the trunk body 2, by applying the above-described lubricating agent to the outer periphery of the trunk body 2, or applying the above-described lubricating material to the inner periphery of the neutron shielding container 3.
(8) The key 10 is attached. If the trunnion 10d is used instead of the key 10, the trunnion 10d is mounted. If the key 10 is not to be used, the key 10 needs not to be attached.

By following the above-described procedure, the radioactive substance storage container 1 is completed. In this method, the cold shrink fit is used. Accordingly, it is possible to form the radioactive substance storage container 1, without exceeding the heat resisting temperature of the neutron shielding body 8 already disposed in the neutron shielding container 3.

### (Second Example of Manufacturing Method)

(1) The trunk body 2 of the radioactive substance storage container 1 is manufactured by casting. In this case, the trunk body 2 is manufactured as a bottomed integral container in which the trunk 2A and the bottom 2B are integrally formed. Cast iron is used as a material for the trunk body 2.
(2) The outer surface of the trunk body 2 is machined into a predetermined shape by cutting, polishing, and the like, thereby achieving the required accuracy.
(3) The inner tube 4 having an inner shape matched with the outer shape of the trunk body 2 is manufactured. The outer casing 5 disposed outside the inner tube 4 is also manufactured. For example, the inner tube 4 and the outer casing 5 in cylindrical shapes are manufactured by connecting the ends of a bent steel plate by welding and the like.
(4) The heat transfer fins 7 are attached between the inner tube 4 and the outer casing 5 by connecting means, such as welding. At this time, at least one of the first end plate 6T and the second end plate 6B is also connected to the end of the inner tube 4 and the end of the outer casing 5. To remove thermal stress, heat treatment such as annealing is performed on the structure being welded.
(5) The neutron shielding container 3 is attached to the trunk body 2. In this case, the neutron shielding body 8 is not yet disposed in the neutron shielding container 3. Accordingly, a cold shrink fit in which the trunk body 2 is cooled or a shrink fit in which the neutron shielding container 3 is heated may be used. The combination of the cold shrink fit and the shrink fit may also be used. To attach the neutron shielding container 3 to the trunk body 2, it is preferable to interpose a lubricating material between the neutron shielding container 3 and the trunk body 2, by applying the above-described lubricating agent to the outer periphery of the trunk body 2, or applying the above-described lubricating material to the inner periphery of the neutron shielding container 3.
(6) The key 10 is attached. If the trunnion 10d is used instead of the key 10, the trunnion 10d is mounted. If the key 10 is not to be used, the key 10 needs not to be attached.
(7) The neutron shielding body 8 in a liquid form is cast into a space formed by the inner tube 4, the outer casing 5, and the heat transfer fins 7. Alternatively, the neutron shielding body 8 solidified and molded into the shape of the space in advance may be inserted into the space.
(8) When the neutron shielding body 8 is cast in, the cast opening is sealed. When the molded neutron shielding body 8 is inserted, an end plate different from the end plate already being fixed is attached.

By following the above-described procedure, the radioactive substance storage container 1 is completed. In this method, the neutron shielding body 8 is disposed into the space formed by the inner tube 4, the outer casing 5, and the heat transfer fins 7, after the neutron shielding container 3 is attached to the trunk body 2. Accordingly, the neutron shielding body is free of temperature limitation. This method is very effective in forming an inexpensive radioactive substance storage container 1. When the shrink fit is used, the neutron shielding container 3 having a smaller heat capacity than that of the trunk body 2 is heated. Consequently, the energy required for heating can also be reduced.

### (Third Example of Manufacturing Method)

(1) The trunk body 2 of the radioactive substance storage container 1 is manufactured by casting. In this case, the trunk body 2 is manufactured as a bottomed integral container in which the trunk 2A and the bottom 2B are integrally formed. Cast iron is used as a material for the trunk body 2.
(2) The outer surface of the trunk body 2 is machined into a predetermined shape by cutting, polishing, and the like, thereby achieving the required accuracy.
(3) The inner tube 4 having an inner shape matched with the outer shape of the trunk body 2 is manufactured. For example, the inner tube 4 in a cylindrical shape is manufactured by connecting the ends of a bent steel plate by welding and the like.
(4) The inner tube 4 is attached to the trunk body 2. In this case, a cool shrink fit in which the trunk body 2 is cooled, or a shrink fit in which the inner tube 4 is heated may be used. To attach the inner tube 4 to the trunk body 2, it is preferable to interpose a lubricating material between the inner tube 4 and the trunk body 2, by applying the above-described lubricating agent to the outer periphery of the trunk body 2, or applying the above-described lubricating material to the inner periphery of the inner tube 4.
(5) The heat transfer fins 7 are attached outside the inner tube 4 by connecting means, such as welding. At least one of the first end plate 6T and the second end plate 6B is also connected to both ends of the inner tube 4 by connecting means, such as welding. When the solidified and molded neutron shielding body 8 is used, at least one of the first end plate 6T and the second end plate 6B is attached to one end of the inner tube 4. To cast the neutron shielding body 8 in a liquid form, the first end plate 6T and the second end plate 6B are attached to the ends of the inner tube 4, respectively. In this case, an opening into which the neutron shielding body 8 is cast is provided to at least one of the first end plate 6T, the second end plate 6B, and the outer casing 5.
(6) The key 10 is attached. If the trunnion 10d is used instead of the key 10, the trunnion 10d is mounted. If the key 10 is not to be used, the key 10 needs not to be attached.
(7) The outer casing 5 in a cylindrical shape manufactured by connecting the ends of a bent steel plate by welding or the like is disposed outside the inner tube 4. The heat transfer fins 7 and the end plate are connected to the outer casing 5 by connecting means, such as by welding.
(8) The neutron shielding body 8 in a liquid form is cast into a space formed by the inner tube 4, the outer casing 5, and the heat transfer fins 7. Alternatively, the neutron shielding body 8 solidified and molded into the shape of the space in advance may be inserted into the space.
(9) When the neutron shielding body 8 is cast in, the cast opening is sealed. When the molded neutron shielding body 8 is inserted, an end plate different from the end plate already being fixed is attached.

By following the above-described procedure, the radioactive substance storage container 1 is completed. In this method, when the shrink fit is used, the inner tube 4 of the neutron shielding container 3 having a smaller heat capacity than that of the neutron shielding container 3 is heated. Consequently, the energy required for heating can further be reduced.

### (Fourth Example of Manufacturing Method)

(1) The trunk body 2 of the radioactive substance storage container 1 is manufactured by casting. In this case, the trunk body 2 is manufactured as a bottomed integral container in which the trunk 2A and the bottom 2B are integrally formed. Cast iron is used as a material for the trunk body 2.
(2) The outer surface of the trunk body 2 is machined into a predetermined shape by cutting, polishing, and the like, thereby achieving the required accuracy.
(3) The inner tube 4 having an inner shape matched with the outer shape of the trunk body 2 is manufactured. For example, the inner tube 4 in a cylindrical shape is manufactured by connecting the ends of a bent steel plate by welding and the like.
(4) The inner tube 4 is attached to the trunk body 2. In this case, a cold shrink fit in which the trunk body 2 is cooled, or a shrink fit in which the inner tube 4 is heated may be used. To attach the inner tube 4 to the trunk body 2, it is preferable to interpose a lubricating material between the inner tube 4 and the trunk body 2, by applying the above-described lubricating agent to the outer periphery of the trunk body 2, or applying the above-described lubricating material to the inner periphery of the inner tube 4.
(5) The first end plate 6T is attached to the end of the inner tube 4 at the side of the flange portion 2F of the trunk body 2 by connecting means, such as welding.
(6) The key 10 is attached. If the trunnion 10d is used instead of the key 10, the trunnion 10d is mounted. If the key 10 is not to be used, the key 10 needs not to be attached.
(7) The heat transfer fins 7 are attached inside the outer casing 5 in a cylindrical shape manufactured by connecting the ends of a bent steel plate by welding and the like, by connecting means, such as welding.
(8) The outer casing 5 to which the heat transfer fins 7 are attached to the inside is disposed outside the inner tube 4, and the heat transfer fins 7 are attached outside the inner tube 4 by connecting means, such as welding. The first end plate is also attached to one end of the outer casing 5 outside the inner tube 4 by connecting means, such as welding. When the solidified and molded neutron shielding body 8 is used, the second end plate 6B is not attached to the inner tube 4 or the outer casing 5. To cast the neutron shielding body 8 in a liquid form, the second end plate 6B is attached to the end of the inner tube 4 and the end of the outer casing 5 at the side of the bottom 2B of the trunk body 2. In this case, an opening into which the neutron shielding body 8 is cast is provided to at least one of the first end plate 6T, the second end plate 6B, and the outer casing 5.
(9) The neutron shielding body 8 in a liquid form is cast into a space formed by the inner tube 4, the outer casing 5, and the heat transfer fins 7. Alternatively, the neutron shielding body 8 solidified and molded into the shape of the space in advance may be inserted into the space.
(10) When the neutron shielding body 8 is cast in, the cast opening is sealed. When the molded neutron shielding body 8 is inserted, an end plate different from the end plate already being fixed is attached.

By following the above-described procedure, the radioactive substance storage container 1 is completed.

In the present embodiment, the trunk body 2 is integrally formed by casting using cast iron as a material. Alternatively, cast steel may also be used as a material for the trunk body 2. Because the cast steel can be welded, even if material defects are found after the material is molded by a casting mold, the defective portion can be advantageously fixed by welding. It is also possible to integrally form the trunk body 2, by forging a billet of steel or stainless steel. The trunk body 2 may also be formed by preparing the trunk 2A and the bottom 2B as separate members, and made into a bottomed container with a bottom by connecting the trunk 2A and the bottom 2B by welding and the like.

(First Modification)

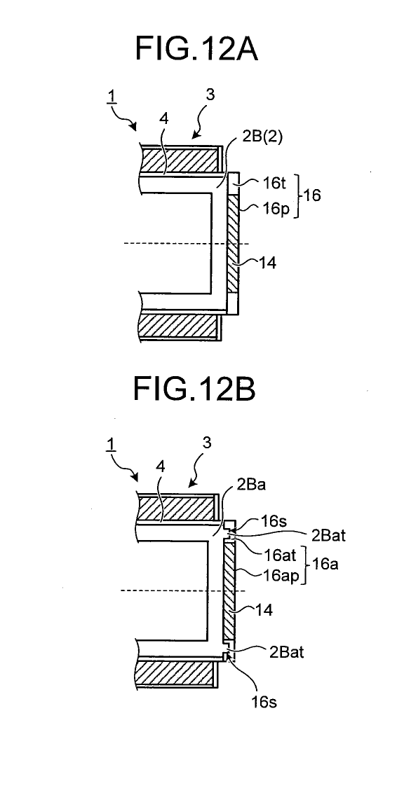

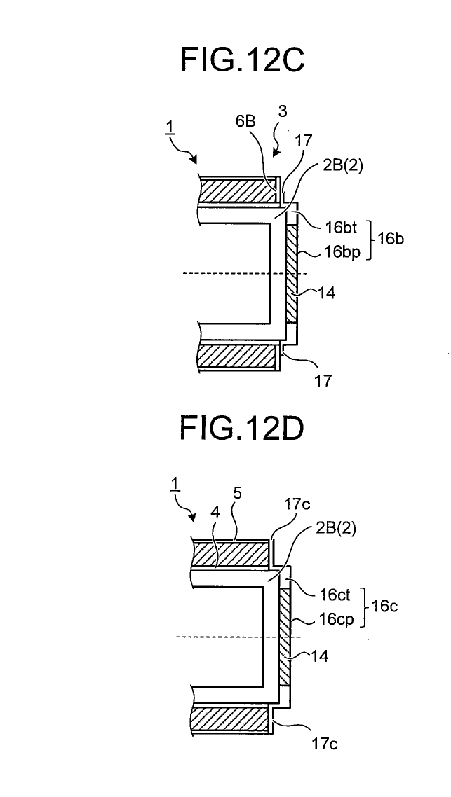

FIG. 13 is a sectional view of a radioactive substance storage container according to a first modification of the present'embodiment, cut along a plane that passes through the axis of the radioactive substance storage container according to the present embodiment. FIG. 14A is a fragmentary view taken along the line A-A in FIG. 13 depicting a state in which the neutron shielding container according to the present embodiment is attached. FIG. 14B is a fragmentary view taken along the line A-A in FIG. 13 depicting a state in which the neutron shielding container according to the present embodiment is not attached. This radioactive substance storage container 1a according to the present modification has a structure substantially the same as that of the radioactive substance storage container 1 according to the embodiment. However, the structure of the radioactive substance storage container 1a is different from that of the radioactive substance storage container 1, in that a neutron shielding container 3a is divided in the direction of the center axis Z of the radioactive substance storage container 1a (in other words, in the longitudinal direction of the radioactive substance storage container 1a). Because other structures are the same as those in the embodiment, the same elements are denoted by the same reference numerals, and descriptions of the same structures, operations, and effects will be omitted.

The neutron shielding container 3a is divided in the direction of the center axis Z of the radioactive substance storage container 1a, in other words, in the longitudinal direction of the radioactive substance storage container 1a. The radioactive substance storage container 1a according to the present modification, as shown in FIGS. 14A and 14B, includes the trunnion mount 2P on the trunk body 2. The trunnion mount 2P is formed by making a part of the trunk body 2 in a plane shape.

The cross section of a portion where the trunnion mount 2P is formed on the trunk body 2 is in a non-circular shape, and the cross section of a portion other than where the trunnion mount 2P is formed is in a circular shape. In this manner, if the trunk body 2 has different cross-sectional shapes in the direction of the center axis Z of the radioactive substance storage container 1, the inner tube 4 of the neutron shielding container 3a also need to have different cross-sectional shapes in the direction of the center axis Z of the radioactive substance storage container 1. In this case, it is difficult to integrally manufacture the neutron shielding container and the inner tube.

In the present modification, to form the trunnion mount 2P on the trunk body 2, the neutron shielding container 3a is divided in the direction of the center axis Z of the radioactive substance storage container 1, and the neutron shielding container 3a is separated into a portion where the trunnion mount 2P is formed and the other portion. In this manner, even if the trunk body 2 has different cross-sectional shapes in the direction of the center axis Z of the radioactive substance storage container 1, the neutron shielding container 3a can be manufactured corresponding to each portion. Accordingly, it is possible to easily manufacture the neutron shielding container 3a.

The neutron shielding container 3a includes a first neutron shielding container 3at attached to a portion where the trunnion mount 2P is formed, and a second neutron shielding container 3am attached to a portion where the trunnion mount 2P is not formed. The cross section of the portion where the trunnion mount 2P is formed on the trunk body 2 is in a non-circular shape. Accordingly, the inner shape of an inner tube 4at of the neutron shielding container 3a is also formed in a plane and a curved shape corresponding to the outer shape of the portion.

In the radioactive substance storage container 1a according to the present modification, in a portion where the trunnion mount 2P is formed on the trunk body 2, the size of the portion where the trunnion mount 2P is formed is smaller than a cross section taken along the line B-B in FIG. 13 in the radial direction. Accordingly, the first neutron shielding container 3at disposed on the trunnion mount 2P is attached to the trunk body 2 while being divided in the circumferential direction. In the present modification, the first neutron shielding container 3at is divided into four in the circumferential direction. In other words, the first neutron shielding container 3at is formed by first neutron shielding container divided bodies 3at1, 3at2, 3at3, and 3at4. However, the first neutron shielding container 3at is not limited to being divided into four, but may be appropriately divided into two, three, and the like, as appropriate to correspond to the outer shape of the trunk body 2. The present modification is advantageous when the shape of the trunk body 2 is peculiar, and simple division of the neutron shielding container 3a in the direction of the center axis Z of the radioactive substance storage container 1a cannot make the shape of the container corresponding thereto.

The position to divide the first neutron shielding container 3at is disposed at a portion of the trunnion mount 2P formed in a plane shape, in other words, at a portion where a plane is formed on the trunk body 2. In this manner, the divided first neutron shielding container 3at can easily be placed close to the trunk body 2, with the divided first neutron shielding container 3at matching with the outer shape of the trunk body 2. When the first neutron shielding container divided bodies 3at1, 3at2, 3at3, and 3at4 are connected by connecting means, such as welding, due to contraction of the welded portion, the first neutron shielding container 3at is pressed against the trunk body 2. Accordingly, a space between the first neutron shielding container 3at and the trunk body 2 can be suppressed to a minimum. Consequently, it is possible to prevent the heat transfer efficiency from the trunk body 2 to the first neutron shielding container 3at from being lowered.

The trunnion mount 2P is provided at the portion where the first neutron shielding container 3at is attached, thereby reducing the projection of the trunnion from the radioactive substance storage container 1a to a minimum. The trunnion mount 2P is formed in a plane shape, and the size thereof in the radial direction is smaller than the cross section cut along the line B-B in FIG. 13. Accordingly, a neutron shielding body 8at this portion is thin compared with that of the other portions and the shielding capability at this portion may not be sufficient for a certain amount of radiation of the recycled fuel stored in the radioactive substance storage container 1a.

Accordingly, a material having higher neutron shielding capability is preferably used for the neutron shielding body 8at of the first neutron shielding container 3at arranged at a portion where the trunnion mount 2P is formed, than that of the other portion, in other words, a neutron shielding body 8am of the second neutron shielding container 3am. That is, it is preferable to increase the hydrogen content of the neutron shielding body 8at in the first neutron shielding container 3at than the hydrogen content of the neutron shielding body 8am in the second neutron shielding container 3am. For example, a neutron shielding material represented by polyethylene is used for the neutron shielding body 8at in the first neutron shielding container 3at, and epoxy resin is used for the neutron shielding body 8am in the second neutron shielding container 3am. Consequently, it is possible to shield neutrons at a portion where the trunnion mount 2P is provided without fail.

In the present modification, the neutron shielding container 3a has a split structure. However, even if the split structure is not adopted, as in the neutron shielding container 3 shown in FIG. 3, a material having higher neutron shielding capability, in other words, a material with higher hydrogen content, is preferably used for the neutron shielding body 8at disposed at a portion where the trunnion mount 2P is formed, than that of the neutron shielding body 8am disposed at the other portion. In this manner, even if the trunnion mount 2P is formed, the neutron shielding capability can be maintained in the direction of the center axis Z of the radioactive substance storage container 1a. If the trunnion mount is also provided at the side of the bottom 2B of the trunk body 2, a material having higher neutron shielding capability, in other words, a material with higher hydrogen content is preferably used for the neutron shielding body disposed at this portion, than that of the neutron shielding body disposed at the other portion.

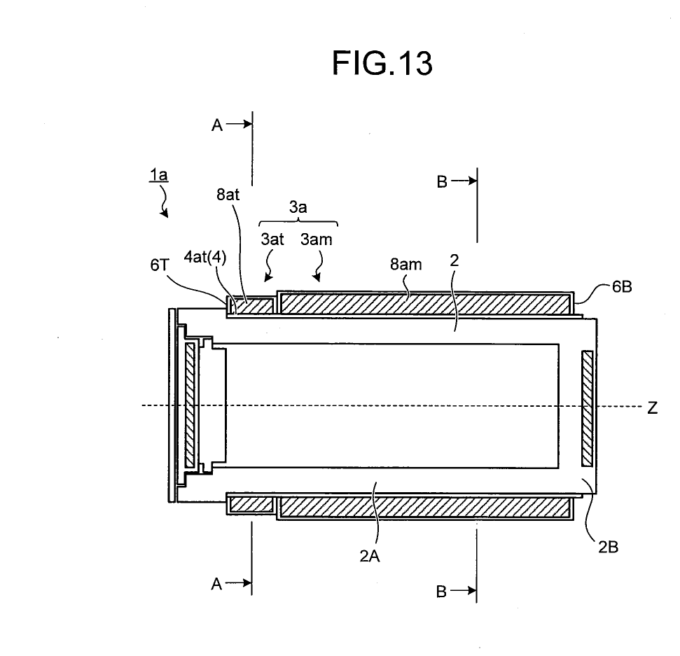

FIG. 15 is an enlarged view of a split portion of the neutron shielding container. As shown in FIG. 15, it is preferable that a space between the first neutron shielding container 3at and the second neutron shielding container 3am is sealed with the sealing member 20 such as resin. In this manner, even if the radioactive substance storage container 1a to which the neutron shielding container 3a is attached is immersed into a fuel storage pool, the water is prevented from entering the space between the first neutron shielding container 3at and the second neutron shielding container 3am. In the present modification, a recess 3as is formed on the first neutron shielding container 3at in the circumferential direction, and the sealing member 20 is disposed in the recess 3as. With such a structure, an amount of the sealing member protruding from the surface of the neutron shielding container 3a can be reduced.

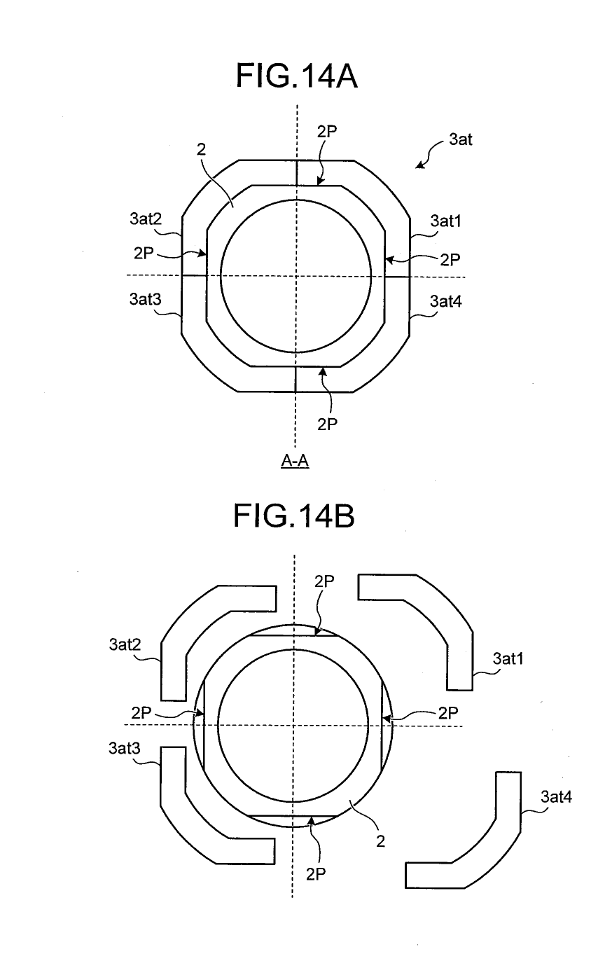

FIGS. 16A and 16B are enlarged views of a structure of the split portion of the neutron shielding container according to the first modification of the present embodiment. When the neutron shielding container 3a is divided into the first neutron shielding container 3at and the second neutron shielding container 3am, as shown in FIG. 16A, a connection portion between the first neutron shielding container 3at and the second neutron shielding container 3am is inclined relative to the center axis Z of the radioactive substance storage container 1a.

In the present modification, an end plate 23 of the first neutron shielding container 3at the side of the second neutron shielding container 3am, and an end plate 24 of the second neutron shielding container 3am at the side of the first neutron shielding container 3at, are inclined relative to the center axis Z of the radioactive substance storage container 1a.

As shown in FIG. 16B, the connection portion between the first neutron shielding container 3at and the second neutron shielding container 3am may be formed in a stair-like shape, inclined relative to the center axis Z of the radioactive substance storage container 1a. In this case, an end plate 25 of the first neutron shielding container 3at the side of the second neutron shielding container 3am, and an end plate 26 of the second neutron shielding container 3am at the side of the first neutron shielding container 3at are formed in a stair-like shape inclined relative to the center axis Z of the radioactive substance storage container 1a.

In this manner, as shown in FIGS. 16A and 16B, at least one of the first neutron shielding body 8at and the second neutron shielding body 8am is present outside the trunk body 2 in the radial direction, at the connection portion between the first neutron shielding container 3at and the second neutron shielding container 3am. As a result, neutrons from recycled fuel can be shielded without fail. In the example shown in FIG. 16A, neutrons may leak out in a certain direction. However, because the side of the lid is an area of non-heating portions of the recycled fuel assembly, and neutrons are leaked from the direction with less number of neutrons. Accordingly, the neutron dose on the surface of the container will not be increased.

In this manner, as shown in FIG. 16B, at least one of the first neutron shielding body 8at and the second neutron shielding body 8am is present outside the trunk body 2 in the radial direction, at the connection portion between the first neutron shielding container 3at and the second neutron shielding container 3am. As a result, it is possible to shield neutrons from the recycled fuel without fail.

(Second Modification)

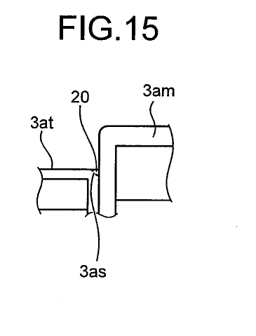

FIG. 17 is a sectional view of a radioactive substance storage container according to a second modification of the present embodiment, cut along a plane that passes through the axis of the radioactive substance storage container according to the present embodiment. A radioactive substance storage container 1b according to the present modification has a structure substantially the same as that of the radioactive substance storage container 1a according to the first modification of the embodiment. However, the structure of the radioactive substance storage container 1b is different from that of the radioactive substance storage container 1a, in that a neutron shielding container 3b is further divided in the direction of the center axis Z of the radioactive substance storage container 1a (in other words, in the longitudinal direction of the radioactive substance storage container 1a). Because other structures are the same as those in the modification, the same elements are denoted by the same reference numerals, and descriptions of the same structures, operations, and effects will be omitted.

The neutron shielding container 3b is divided into three in the direction of the center axis Z of the radioactive substance storage container 1b, in other words, in the longitudinal direction of the radioactive substance storage container 1b. In other words, the neutron shielding container 3b is divided into a first neutron shielding container 3bt, a second neutron shielding container 3bm, and a third neutron shielding container 3bn corresponding to the side of a flange portion 2Fb, a portion of the trunk 2A, and a portion of the bottom 2B, respectively. The first neutron shielding container 3bt, the second neutron shielding container 3bm, and the third neutron shielding container 3bn incorporate a first neutron shielding body 8bt, a second neutron shielding body 8bm, and a third neutron shielding body 8bn, respectively. In this manner, depending on the specification of the radioactive substance storage container, the division number of the neutron shielding container can be appropriately changed.

(Third Modification)

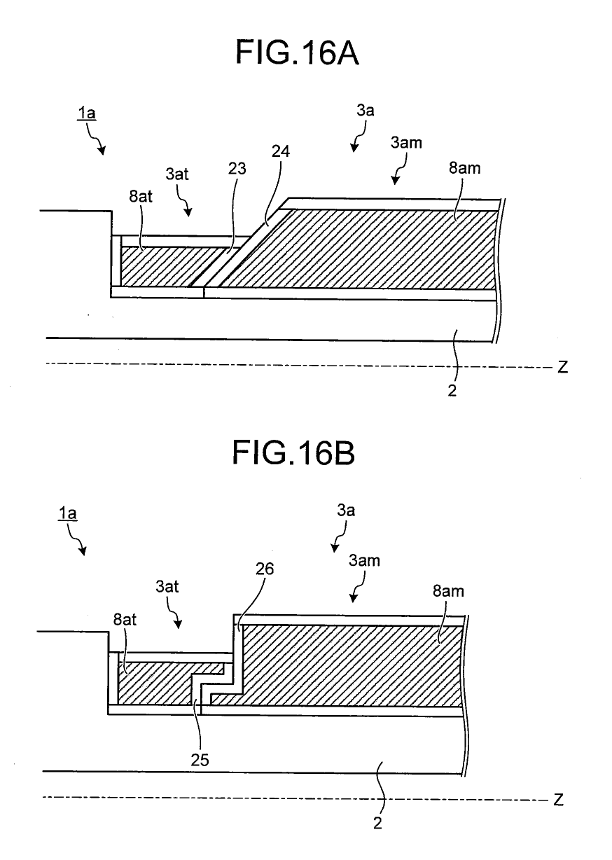

FIG. 18 is a sectional view of a radioactive substance storage container according to a third modification of the present embodiment, cut along a plane that passes through the axis of the radioactive substance storage container according to the present embodiment. A radioactive substance storage container 1c according to the present modification has a structure substantially the same as that of the radioactive substance storage container 1 according to the embodiment. However, the structure of the radioactive substance storage container 1c is different from that of the radioactive substance storage container 1, in that the trunk 2Ac of the trunk body 2 at the side of a flange portion 2Fc is formed in a stair-like shape to comply with the outer diameter of the flange portion 2Fc in a stepwise manner, and the inner shape of a neutron shielding container 3c is matched with the outer shape of a trunk body 2c. Because other structures are the same as those in the embodiment, the same elements are denoted by the same reference numerals, and descriptions of the same structures, operations, and effects will be omitted.

Flat portions in stages, screw holes, and the like are processed on the inner surface of the trunk body 2c at the side of an opening 2Hc, to fix the primary cover 11 and the like. A flat portion on which a trunnion is mounted is processed outside the trunk body 2c. Accordingly, the trunk body 2c at the side of the opening 2Hc is shaped so that the stress concentration is likely to occur. If the radioactive substance storage container 1c is dropped or collides with something during transportation, a stress concentration occurs at a portion where the shape of the trunk body 2c changes abruptly, due to the external force applied to the trunk body 2c or the load caused by the weight of the trunk body 2c. The degree of stress concentration depends on the shape.

Accordingly, to reduce the degree of stress concentration, the trunk body 2c of the radioactive substance storage container 1c according to the present modification includes a step portion 2D at the side of the opening 2Hc having a complicated inner shape. The outer shape of the portion is formed in a stair-like shape, and the trunk body 2c is formed so that the diameter of the trunk 2Ac complies with the diameter of the flange portion 2Fc in a stepwise manner. In this manner, predetermined thicknesses C1 and C2 of the trunk body 2c are provided at the side of the opening 2Hc. As a result, the structural integrity of the radioactive substance storage container 1c can be ensured.

In the present modification, the inner shape of an inner tube 4c of the neutron shielding container 3c is matched with the outer shape of the trunk body 2c. In other words, the outer shape of the trunk 2Ac at the side of the opening 2Hc of the trunk body 2c is formed in a stair-like shape. Accordingly, the inner shape of the inner tube 4c at this portion is also formed in a stair-like shape. In this manner, the inner tube 4c and the outer casing 5c come in contact with each other over the entire surface of the inner tube 4c of the neutron shielding container 3c. Consequently, it is possible to provide heat transfer performance.

The neutron shielding container 3c includes a first neutron shielding unit 3ct at the side of the flange portion 2Fc and a second neutron shielding unit 3cm at the side of a bottom 2Bc. A neutron shielding body in the first neutron shielding unit 3ct is called a first neutron shielding unit shielding body 8ct, and a neutron shielding body in the second neutron shielding unit 3cm is called a second neutron shielding unit shielding body 8cm. In the present modification, the movement of the neutron shielding container 3c towards the side of the flange portion 2Fc is restricted, by bringing the first end plate 6T of the neutron shielding container 3c in contact with the flange portion 2Fc.

A thermal expansion absorbing layer 9T for absorbing expansion of the first neutron shielding unit shielding body 8ct due to temperature rise, is provided between the first neutron shielding unit 3ct at the side of the flange portion 2Fc, in other words, at the side of the first end plate 6t, and the first neutron shielding unit shielding body 8ct. Thermal expansion absorbing layers 9A1 and 9A2 are also provided outside an outer casing 5cm of the second neutron shielding unit 3cm in the radial direction, to absorb the expansion of the second neutron shielding unit shielding body 8cm due to temperature rise. An elastic body having good heat conductivity such as aluminum alloy honeycomb is preferably used for the thermal expansion absorbing layers 9T, 9A1, and 9A2. In this manner, the heat can transfer between the first neutron shielding unit shielding body 8ct and the first end plate 6T, and between the second neutron shielding unit shielding body 8cm and the outer casing 5cm.

In the present modification, instead of providing the thermal expansion absorbing layer outside the second neutron shielding unit 3cm in the radial direction, over the entire region in the direction of the center axis Z of the radioactive substance storage container 1c, as shown in FIG. 18, the thermal expansion absorbing layers 9A1 and 9A2 are only provided at the side of the flange portion 2Fc and the side of the bottom 2Bc of the second neutron shielding unit 3cm. Alternatively, the thickness (size of the neutron shielding container 3c in the radial direction) of the thermal expansion absorbing layer of the second neutron shielding unit 3cm between the side of the flange portion 2Fc and the side of the bottom 2Bc is smaller than the thermal expansion absorbing layers 9A1 and 9A2 at the side of the flange portion 2Fc and the bottom 2Bc. Accordingly, the second neutron shielding unit shielding body 8cm can have a certain thickness at the center of the second neutron shielding unit 3cm.

The recycled fuel is stored in a trunk body inner space 2Ic of the radioactive substance storage container 1c in a form of a recycled fuel assembly. Because the neutron density of the recycled fuel at the center portion in the longitudinal direction becomes large, it is also preferable to increase the neutron shielding capability of the neutron shielding container 3c at this portion. By forming the thermal expansion absorbing layers 9A1 and 9A2 on the second neutron shielding unit 3cm, as described above, the thick second neutron shielding unit shielding body 8cm can be disposed at a portion where the neutron density is the highest. Accordingly, it is possible to shield neutrons from the recycled fuel without fail, while preventing the thermal expansion of the neutron shielding body.

(Fourth Modification)

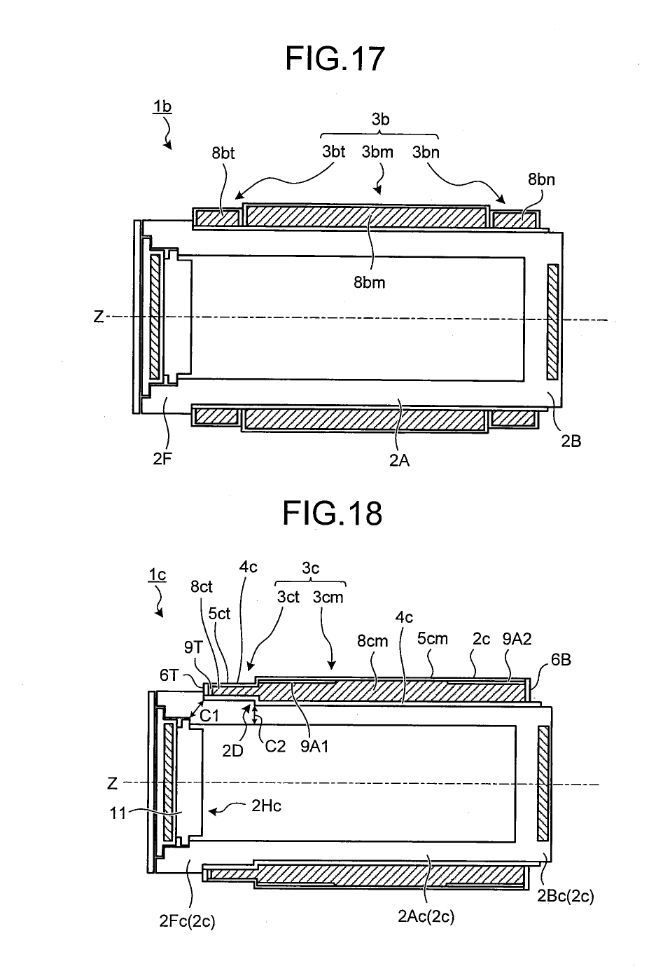

FIG. 19 is a sectional view of a radioactive substance storage container according to a fourth modification of the present embodiment, cut along a plane that passes through the axis of the radioactive substance storage container according to the present embodiment. This radioactive substance storage container 1d according to the present modification has a structure substantially the same as that of the radioactive substance storage container is according to the third modification of the embodiment. However, the radioactive substance storage container 1d is different from that of the radioactive substance storage container 1c, in that the neutron shielding container 3b is divided in the direction of the center axis Z of the radioactive substance storage container 1d (in other words, in the longitudinal direction of the radioactive substance storage container 1d). Because other structures are the same as those in the modification, the same elements are denoted by the same reference numerals, and descriptions of the same structures, operations, and effects will be omitted.

As described above, a trunk body 2d at the side of an opening 2Hd has a shape in which the stress concentration is likely to occur. Accordingly, to reduce the degree of stress concentration, the trunk body 2d of the radioactive substance storage container 1d according to the present modification includes the step portion 2D outside the side of the opening 2Hd having a complicated inner shape. The trunk body 2d is formed by forming the outer shape of this portion in a stair-like shape, and so that the diameter of a trunk 2Ad becomes the diameter of a flange portion 2Fd in a stepwise manner.

A neutron shielding container 3d includes a first neutron shielding container 3dt disposed between the step portion 2D and the flange portion 2Fd, and a second neutron shielding container 3dm disposed between the step portion 2D and a bottom 2Bd. If the above-described trunnion mount is formed between the step portion 2D and the flange portion 2Fd, the thickness of a neutron shielding body 8dt of the first neutron shielding container 3dt becomes thinner than the thickness of a neutron shielding body 8dm of the second neutron shielding container 3dm.

When the thickness of an inner tube 4dt of the first neutron shielding container 3dt is made the same as the thickness of an inner tube 4dm of the second neutron shielding container 3dm, the thickness of the neutron shielding body 8dt of the first neutron shielding container 3dt is even smaller. Accordingly, the neutron shielding function may not be sufficient. As a result, the thickness of the inner tube 4dt of the first neutron shielding container 3dt needs to be smaller than the thickness of the inner tube 4dm of the second neutron shielding container 3dm. However, it is difficult to manufacture the inner tubes 4dt and 4dm having different thicknesses integrally and continuously. In addition, the shapes of the inner tubes 4dt and 4dm need to be matched with the step portion 2D. Consequently, in the radioactive substance storage container 1d including the trunk body 2d to which the step portion 2D is provided outside the side of the opening 2Hd, it is difficult to manufacture the neutron shielding container 3d integrally.

To prevent this from happening, in the present modification, the neutron shielding container 3d includes the first neutron shielding container 3dt and the second neutron shielding container 3dm, in a way that the both portions can exert the required functions. The first neutron shielding container 3dt is disposed at a portion between the step portion 2D and the flange portion 2Fd having a complicated shape because the trunnion mount and the like are formed. Because the size of the first neutron shielding container 3dt is small in the direction of the center axis Z of the radioactive substance storage container 1d, the rigidity of the first neutron shielding container 3dt may be low. Accordingly, the neutron shielding body 8dt can have a certain thickness, by reducing the thickness of the inner tube 4dt of the first neutron shielding container 3dt, which is a part of the neutron shielding body 8dt. As a result, the neutron shielding function can be provided also at a portion where the first neutron shielding container 3dt is attached. Because the size of the first neutron shielding container 3dt is small in the direction of the center axis Z of the radioactive substance storage container 1d, the manufacturing thereof is relatively easy. Consequently, the first neutron shielding container 3dt can more readily correspond to complicated shapes.

(Fifth Modification)

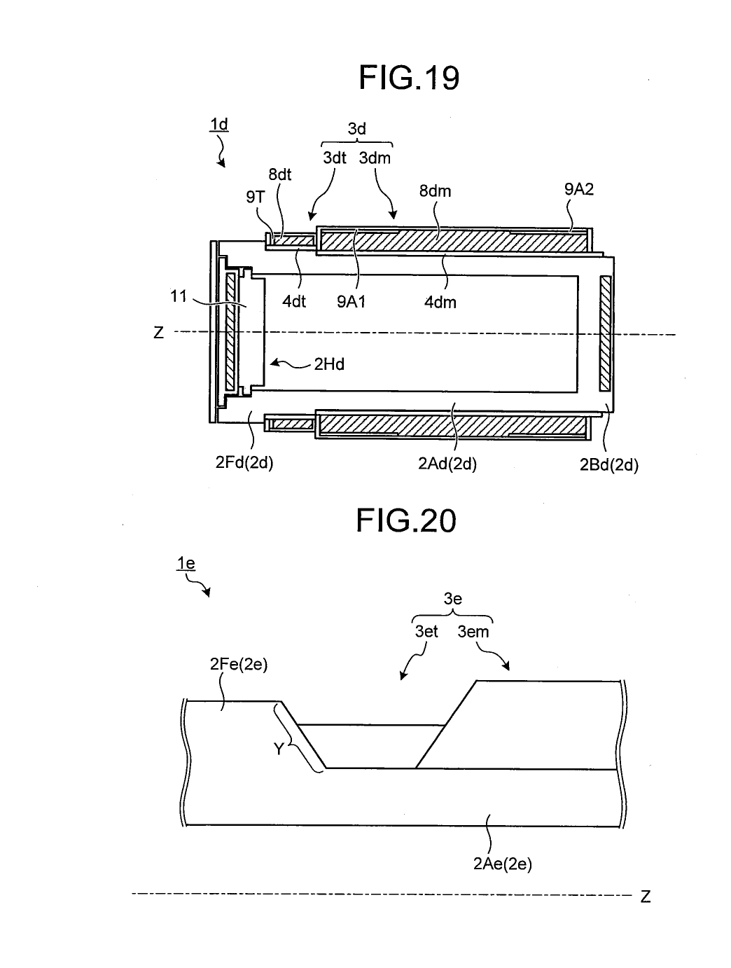

FIG. 20 is an enlarged view of an area near a flange portion of a radioactive substance storage container according to a fifth modification of the present embodiment. A radioactive substance storage container 1e according to the present modification has a structure substantially the same as that of the radioactive substance storage container 1a according to the second modification. However, the structure of the radioactive substance storage container 1e is different from that of the radioactive substance storage container 1a, in that a flange portion 2Fe is inclined relative to the center axis Z of the radioactive substance storage container 1e. Because other structures are the same as those in the modification, the same elements are denoted by the same reference numerals, and descriptions of the same structures, operations, and effects will be omitted.

An inclined portion Y inclined relative to the center axis Z of the radioactive substance storage container 1e, is provided between the flange portion 2Fe and a trunk 2Ae of a trunk body 2a of the radioactive substance storage container 1e. Accordingly, the stress between the trunk 2Ae and the flange portion 2Fe is relieved. A neutron shielding container 3e attached to the trunk body 2e includes a first neutron shielding container 3et and a second neutron shielding container 3em.

The shape of the first neutron shielding container 3et at the side of the flange portion 2Fe is matched with the inclined portion Y of the flange portion 2Fe. In other words, the first neutron shielding container 3et at the side of the flange portion 2Fe is inclined relative to the center axis Z of the radioactive substance storage container 1e. Accordingly, the flange portion 2Fe and the first neutron shielding container 3et come in contact with each other without fail, thereby increasing a contact area between the flange portion 2Fe and the first neutron shielding container 3et. As a result, the load in the direction of the center axis Z of the radioactive substance storage container 1e can be more easily received.

The first neutron shielding container 3et at the side of the second neutron shielding container 3em, and the second neutron shielding container 3em at the side of the second neutron shielding container 3et are also inclined relative to the center axis Z of the radioactive substance storage container 1e. Accordingly, a contact area between the flange portion 2Fe and the fist neutron shielding container 3et is increased. As a result, the load in the direction of the center axis Z of the radioactive substance storage container 1e can be more easily received.

The radioactive substance storage container 1 according to the present embodiment and the modifications includes a metal trunk body in which recycled fuel is stored, a neutron shielding container having an inner member in a cylindrical shape attached outside the trunk body by being fitted thereto, an outer member in a cylindrical shape disposed outside the inner member, and heat transfer members that connect the inner member and the outer member, and a neutron shielding body disposed inside the neutron shielding container. In this manner, because the neutron shielding container is attached to the trunk body by being fitted thereto, the radioactive substance storage container can be easily dismantled, by removing the inner member from the trunk body.

### INDUSTRIAL APPLICABILITY

In this manner, the radioactive substance storage container according to the present invention can be advantageously used for transporting and storing recycled fuel, and more particularly, is advantageous upon dismantling.

1. A radioactive substance storage container comprising:
a trunk body formed of metal that is a bottomed container including a trunk in a cylindrical shape, a bottom provided at one end of the trunk, and an opening opened to a side opposite from the bottom, and that stores a radioactive substance in a space formed by the trunk and the bottom;
a neutron shielding container that includes an inner member in a cylindrical shape attached to the trunk body by being fitted thereto, an outer member in a cylindrical shape disposed outside the inner member, and heat transfer members that connect the inner member and the outer member; and
a neutron shielding body that is disposed in a space surrounded by the inner member, the outer member, and the heat transfer members adjacent to each other of the neutron shielding container.

2. The radioactive substance storage container according to claim 1, wherein the trunk body is a bottomed integral container in which the trunk and the bottom are integrally formed.

3. The radioactive substance storage container according to claim 1, wherein the trunk body is made of cast iron.

4. The radioactive substance storage container according to claim 3, wherein the trunk body is integrally formed with the trunk body and the bottom by using a casting mold.

5. The radioactive substance storage container according to claim 1, wherein a lubricating material for reducing friction between the trunk body and the inner member is interposed between the trunk body and the inner member.

6. The radioactive substance storage container according to claim 5, wherein the lubricating material includes a heat conductor.

7. The radioactive substance storage container according to claim 6, wherein the lubricating material is a metal paste or a carbon paste.

8. The radioactive substance storage container according to claim 1, wherein a recess is formed at an outer side of the trunk in a circumferential direction of the trunk.

9. The radioactive substance storage container according to claim 1, wherein a release layer for preventing the neutron shielding body from adhering is provided on an inner surface of a space surrounded by the inner member, the outer member, and the heat transfer members of the neutron shielding container.

10. The radioactive substance storage container according to claim 1, wherein the neutron shielding container is attached to the trunk body, by using a shrink fit in which the neutron shielding container is fitted to the trunk body after being heated.

11. The radioactive substance storage container according to claim 1, wherein the neutron shielding container is attached to the trunk body, by using a cold shrink fit in which the neutron shielding container is fitted to the trunk body after the trunk body is cooled.

12. The radioactive substance storage container according to claim 1, wherein the neutron shielding container is fixed to the trunk body by an engagement member provided at the trunk body.

13. The radioactive substance storage container according to claim 12, wherein the engagement member is provided in plurality in a circumferential direction of the trunk body.

14. The radioactive substance storage container according to claim 12, wherein the engagement member is a hoisting attachment provided at the trunk body, and used for hoisting at least the radioactive substance storage container.

15. The radioactive substance storage container according to claim 1, wherein the neutron shielding container is divided in a longitudinal direction of the trunk body.

16. The radioactive substance storage container according to claim 15, wherein the neutron shielding container provided at the opening of the trunk body among such neutron shielding containers being divided is divided in a circumferential direction of the neutron shielding container.

17. A method for manufacturing a radioactive substance storage container comprising:
a step of disposing a neutron shielding body in a space surrounded by an inner member, an outer member, and heat transfer members adjacent to each other of a neutron shielding container including the inner member in a cylindrical shape, the outer member in a cylindrical shape disposed outside the inner member, and the heat transfer members that connect the inner member and the outer member; and
a step of fitting the neutron shielding container to a trunk body that is a bottomed container including a trunk in a cylindrical shape, a bottom provided at one end of the trunk, and an opening opened to a side opposite from the bottom.

18. A method for manufacturing a radioactive substance storage container comprising:
a step of fitting a neutron shielding container including an inner member in a cylindrical shape, an outer member in a cylindrical shape disposed outside the inner member, and heat transfer members that connect the inner member and the outer member, to a trunk body that is a bottomed container including a trunk in a cylindrical shape, a bottom provided at one end of the trunk, and an opening opened to a side opposite from the bottom; and
a step of disposing a neutron shielding body in a space surrounded by the inner member, the outer member, and the heat transfer members adjacent to each other of the neutron shielding container.

19. The method for manufacturing the radioactive substance storage container according to claim 17, wherein a lubricating material for reducing friction between the trunk body and the inner member is applied at least to one of an inner periphery of the inner member of the neutron shielding container and an outer periphery of the trunk body, before the neutron shielding container is fitted to the trunk body.

20. A method for manufacturing a radioactive substance storage container comprising:
a step of fitting an inner member in a cylindrical shape to a trunk body that is a bottomed container including a trunk in a cylindrical shape, a bottom provided at one end of the trunk, and an opening opened to a side opposite from the bottom;
a step of attaching heat transfer members outside the inner member;
a step of attaching an outer member in a cylindrical shape outside the heat transfer members; and
a step of disposing a neutron shielding body in a space surrounded by the inner member, the outer member, and the heat transfer members adjacent to each other of the neutron shielding container.

21. A method for manufacturing a radioactive substance storage container comprising:
a step of fitting an inner member in a cylindrical shape to a trunk body that is a bottomed container including a trunk in a cylindrical shape, a bottom provided at one end of the trunk, and an opening opened to a side opposite from the bottom;
a step of attaching heat transfer members to an inner side of an outer member in a cylindrical shape disposed outside the heat transfer members;
a step of disposing the heat transfer members and the outer member outside the inner member, and attaching the heat transfer members outside the inner member; and
a step of disposing a neutron shielding body in a space surrounded by the inner member, the outer member, and the heat transfer members adjacent to each other of the neutron shielding container.

22. The method for manufacturing the radioactive substance storage container according to claim 20, wherein a lubricating material for reducing friction between the trunk body and the inner member is applied at least to one of an inner periphery of the inner member and an outer periphery of the trunk body, before the inner member is fitted to the trunk body.
